(19) United States
(12) Patent Application Publication
(10) Pub. No.: US 2018/0233914 A1
(43) Pub. Date: Aug. 16, 2018

(54) CONTROL DEVICE, ENERGY MANAGEMENT DEVICE, SYSTEM, AND CONTROL METHOD

(71) Applicant: SHARP KABUSHIKI KAISHA, Sakai City, Osaka (JP)

(72) Inventors: HIROSUKE MIKI, Sakai City (JP); RYUTO KOBAYASHI, Sakai City (JP); KAZUO YAMADA, Sakai City (JP)

(73) Assignee: Sharp Kabushiki Kaisha, Sakai City, Osaka (JP)

(21) Appl. No.: 15/750,919

(22) PCT Filed: Jul. 27, 2016
(86) PCT No.: PCT/JP2016/072065

§ 371 Date: Feb. 7, 2018

(30) Foreign Application Priority Data
Aug. 7, 2015 (JP) 2015-156754
Aug. 31, 2015 (JP) 2015-170059

(51) Int. Cl. H02J 3/32; H02J 7/00; H02J 13/00; H02J 3/38; G05B 13/02

(52) U.S. Cl. CPC H02J 3/32; H02J 7/0068; H02J 13/0006; H02J 7/35; H02J 3/386; G05B 13/026; H02J 3/383

(57) ABSTRACT

A system includes: an energy storage device capable of storing electric power in a predetermined form; and a control device including a control unit that controls the energy storage device. The control unit controls the energy storage device based on output restriction information on an output-restricting period during which output of electric power from a power generation facility operated in conjunction with an electric power system to the electric power system is restricted, such that the electric power generated in the power generation facility is stored in the energy storage device during the output-restricting period.

### TECHNICAL FIELD

The present invention relates to devices at control storage batteries and other like energy storage devices.

### BACKGROUND ART

There have been high expectations for solar cells, wind power generators, and other power generation systems that rely on renewable energy for power source. A problem with these systems is that their power generation, being dependent on weather and other natural conditions, does not always match power demand. Also, distributed power sources such as solar power plants, if connected in large numbers to an electric power system, could affect the supply and demand balance of the electric power system and render the electric power system unstable.

If plenty of solar power is generated on low-demand days, for example, during a long holiday season, electric power is exported to the electric power system in large quantity, and there may occur a surplus of electric supply in the electric power system. To prevent this surplus of electric supply from negatively affecting the electric power system (e.g., to inhibit voltage surges), the operator of the electric power system (e.g., an electric power company) is permitted to place restrictions on the export (reverse power flow) of power to the electric power system (“output restriction”) by, for example, disconnecting solar power plants from the electric power system. Meanwhile, power generation by a solar power plant increases and decreases with insolation, weather, and other conditions (e.g., variations in insolation in the early morning and in the late afternoon and influence of clouds due to changes in the weather), which could cause abrupt output variations of the electric power exported to the electric power system. To alleviate negative effects of these short-term output variations on the electric power system, the output variation per minute needs to be lowered, for example, to or below 1%/min of the rated electric power by installing a power storage or like device when a new solar power plant is built.

An example of conventional art related to the present invention, disclosed in Patent Literature 1, is a power generation system including solar cells and a power storage device. In this power generation system, when the system voltage rises due to excessive export of electric power to the electric power system, the export is stopped, and the generated electric power is stored in the power storage device.

Another example of conventional art related to the present invention, disclosed in Patent Literature 2, is a power generation system in which electric power is generated and converted to the heat of hot water contained in a hot water tank.

### CITATION LIST

### Patent Literature

Patent Literature 1: Japanese Patent No. 5738212

Patent Literature 2: Japanese Unexamined Patent Application Publication, No. 2014-166114

### SUMMARY OF INVENTION

### Technical Problem

These conventional art examples still have some problems. If a solar power plant is disconnected from an electric power system, the solar power plant may need to restrict the electric power generation thereof during the disconnection period. When such a situation actually happens, that electric power which otherwise would be generated cannot be sold to the electric power system. Therefore, power generation efficiency falls, and the decrease of the electric power sold to the electric power system reduces the revenue of the solar power plant. During the disconnection period, the solar power plant typically does not use a power storage device, for example, to alleviate or cancel out output variations (i.e., no charging/discharging operation takes place in the solar power plant).

In relation to these problems, Patent Literature 1 fails to disclose that the solar power plant is disconnected from the electric power system. Furthermore, in the power generation system of Patent Literature 1, when the power storage device has a high charge ratio, the power storage device cannot be charged much or cannot be charged at all because the power storage device is charged by generated electric power in accordance with a rise in the system voltage.

In the power generation system of Patent Literature 2, electric power is used only to heat water, not for any other purposes. Additionally, the control criterion for output restriction in Patent Literature 2 is a voltage on the electric power system. The power generation system is not adapted to, for example, a scheme in which the renewable energy power generation output is controlled remotely. Furthermore, if water is already hot enough on an output restriction, it is impossible to further heat the water. While this problem may be avoided by using up hot water in advance, but hot water only offers limited, hence inflexible usages. It is likely that electric power is wasted during the output restriction. This approach is especially problematic in the summer when the solar power generator produces much power, but typically not much hot water is used.

The present invention, in view of these problems, has an object to increase daily total electric power generation by effectually using generated electric power during output-restricting periods.

### Solution to Problem

To achieve the above object, the present invention, in one aspect thereof, is directed to a control device controlling an energy storage device capable of storing electric power generated in a power generation facility that is operated in conjunction with an electric power system, the control device: controlling the energy storage device based on output restriction information on an output-restricting period during which electric power outputted from the power generation facility to the electric power system is restricted, such that the energy storage device stores the generated electric power during the output-restricting period.

To achieve the above object, the present invention, in another aspect thereof, is directed to a control device controlling an energy storage device capable of storing electric power generated in a power generation facility that is operated in conjunction with an electric power system, the control device controlling the energy storage device based on a prediction of how much electric power is generated by a power generation device in the power generation facility in each time period of a day and also based on output restriction information on an output-restricting period during which electric power outputted from the power generation facility to the electric power system is restricted, such that the energy storage device stores the generated electric power during the output-restricting period, the prediction being made based on information on a factor for day-to-day and period-to-period variations of the generated electric power.

To achieve the above object, the present invention, in yet another aspect thereof, is directed to a control device controlling an energy storage device capable of storing electric power generated in a power generation facility that is operated in conjunction with an electric power system, the control device, if output restriction information on an output-restricting period during which electric power outputted from the power generation facility to the electric power system is restricted indicates that there is such an output-restricting period, controlling a charge level of the energy storage device during the output-restricting period based on the output restriction information, such that the charge level is lower than would be if the output restriction information indicated that there was no output-restricting period at that time.

To achieve the above object, the present invention, in still another aspect thereof, is directed to a system including: a control device; and an energy storage device, the control device controlling the energy storage device capable of storing electric power generated in a power generation facility that is operated in conjunction with an electric power system, the control device controlling the energy storage device based on output restriction information on an output-restricting period during which electric power outputted from the power generation facility to the electric power system is restricted, such that the energy storage device stores the generated electric power during the output-restricting period.

To achieve the above object, the present invention, in yet still another aspect thereof, is directed to a control method executed by a control device controlling an energy storage device capable of storing electric power generated in a power generation facility that is operated in conjunction with an electric power system, the method including controlling the energy storage device based on output restriction information on an output-restricting period during which electric power outputted from the power generation facility to the electric power system is restricted, such that the energy storage device stores the generated electric power during the output-restricting period.

To achieve the above object, the present invention, in a further aspect thereof, is directed to an energy management system controlling charging/discharging of a battery, the energy management system including: an electric power generation unit; a storage battery unit; a power output restriction planning unit; and a control unit, the control unit transmitting a discharge instruction to instruct the storage battery unit to discharge either over an entire period that lasts from a planned input time to a restriction start time or during a part of that period if the power output restriction planning unit already has an output restriction plan and transmitting a charge instruction to charge the storage battery unit with electric power generated by the electric power generation unit either over an entire restriction period or during a part of the restriction period.

To achieve the above object, the present invention, in yet a further aspect thereof, is directed to an energy management device controlling charging of a storage battery with electric power generated by an energy power generation device and discharging of the storage battery, the energy management device including a power output restriction planning unit and a control unit, wherein the control unit transmits a discharge instruction to instruct the storage battery to discharge either over an entire period that lasts from a planned input time to a restriction start time or during a part of that period when the control unit receives an output restriction plan from the power output restriction planning unit and transmits a charge instruction to charge the storage battery with the electric power generated by the energy power generation device either over an entire restriction period or during a part of the restriction period.

To achieve the above object, the present invention, in still a further aspect thereof, is directed to a control method executed by an energy management device controlling charging of a storage battery with electric power generated by an energy power generation device and discharging of the storage battery, the method including: obtaining an output restriction plan according to which an output of the energy power generation device is restricted; transmitting a discharge instruction to instruct the storage battery to discharge either over an entire period that lasts from a time when the output restriction plan is obtained to a start of a restriction period contained in the output restriction plan or during a part of that period; and transmitting a charge instruction to charge the storage battery with the electric power generated by the energy power generation device either over the entire restriction period or during a part of the restriction period.

Additional features and advantages of the present invention will be made more apparent in the description of embodiments.

### Advantageous Effects of Invention

The present invention increases total daily electric power generation by effectually using the electric power generated during the output-restricting period. The electric power that cannot be outputted to the system during the electric power restriction determined by an electric power company can be used in a broader range of applications by charging/discharging the storage battery in a suitable manner.

### BRIEF DESCRIPTION OF DRAWINGS

FIG. 1 is a block diagram of a first configuration example of a power generation system.

FIG. 2 is a flow chart depicting an electric power control process in the first configuration example.

FIG. 3 is a graph representing exemplary control of charging/discharging of a power storage device in accordance with a first embodiment.

FIG. 4 is a block diagram of a second configuration example of a solar power generation system.

FIG. 5 is a flow chart depicting an electric power control process in the second configuration example.

FIG. 6 is a graph representing exemplary control of charging/discharging of a power storage device in accordance with a second embodiment.

FIG. 7 is a graph representing exemplary control of charging/discharging of a power storage device in accordance with a third embodiment.

FIG. 8 is a diagram representing an overall configuration of an electric power system including an energy management system in accordance with a fourth embodiment and further including a solar power generation system and separate inverters.

FIG. 9 is a flow chart depicting a process in an energy management system in accordance with the fourth embodiment.

FIG. 10 is a diagram representing exemplary control of charging/discharging of a storage battery with solar-generated electric power on a cloudy day in an energy management system in accordance with the fourth embodiment.

FIG. 11 is a diagram representing exemplary control of charging/discharging of a storage battery for the purpose of peak shifting in an energy management system in accordance with the fourth embodiment.

FIG. 12 is a diagram representing an example of the operation represented in the preceding flow chart, as implemented by an energy management system in accordance with the fourth embodiment.

FIG. 13 is a diagram representing an overall configuration of an electric power system including an energy management system in accordance with a fifth embodiment and further including a solar power generation system and a hybrid inverter.

FIG. 14 is a diagram representing an overall configuration of an electric power system including an energy management system in accordance with a sixth embodiment and further including a solar power generation system, a hybrid inverter, and a load.

FIG. 15 is a diagram representing exemplary control of charging/discharging of a storage battery for the purpose of peak clipping in an energy management system in accordance with the fourth embodiment.

FIG. 16 is a diagram representing an overall configuration of an electric power system including an energy management system in accordance with a seventh embodiment and further including a wind power generation system, a hybrid inverter, and a load.

### DESCRIPTION OF EMBODIMENTS

The following will describe embodiments of the present invention in reference to drawings.

### First Embodiment

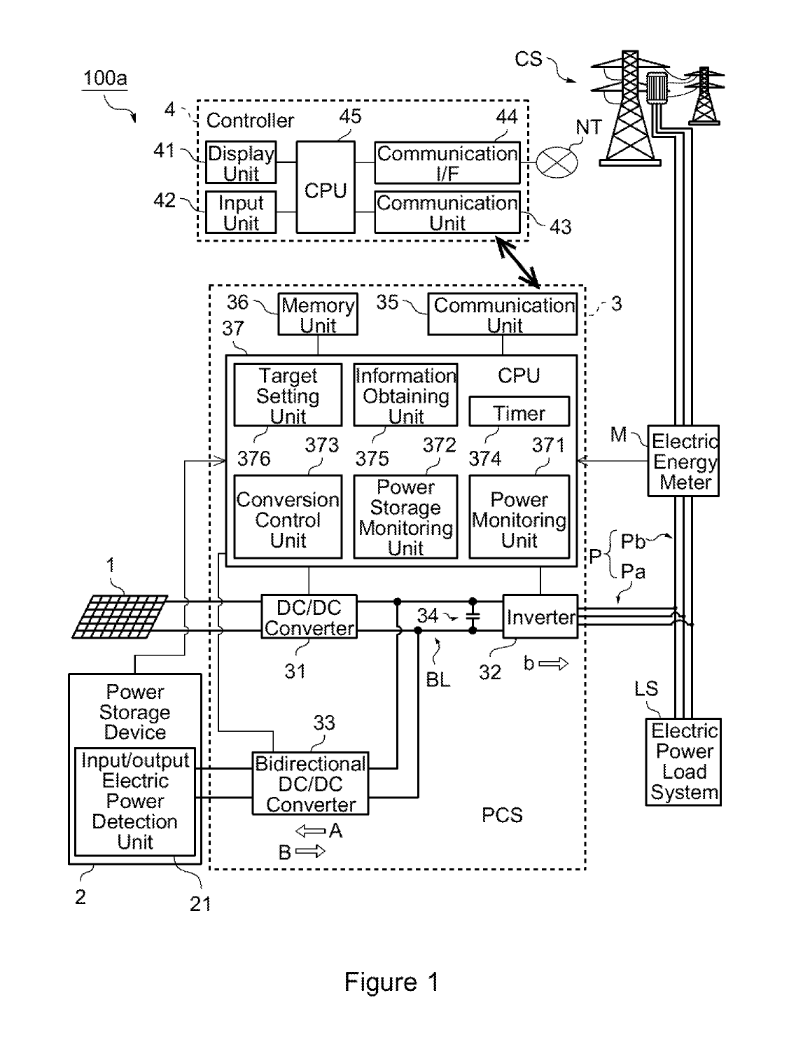

FIG. 1 is a block diagram of a first configuration example of a power generation system 100a. The power generation system 100a is a power generation facility used as a distributed industrial power source and electrically connected to a commercial electric power system CS and an electric power load system LS via, for example, a single-phase three-wire power distribution path P. In this power generation system 100a, a string of solar cells 1, a power storage device 2, and the commercial electric power system CS can be operated in conjunction with each other. Specifically, in the power generation system 100a, electric power is generated and converted from DC to AC, exported (outputted) to the commercial electric power system CS via the power distribution path P, and sold to an electric power company, Throughout the following description, the electric power that is exported to the commercial electric power system CS via the power distribution path P (sold to an electric power company) will be referred to as the “exported electric power,” and the electric power that is supplied from the commercial electric power system CS via the power distribution path P (bought from an electric power company) will be referred to as the “received electric power.”

The power distribution path P includes a first power distribution path Pa and a second power distribution path Pb. The first power distribution path Pa is connected to a power conditioner 3 of the power generation system 100a. The power conditioner 3 will be referred to as the “PCS (power conditioning system) 3” in the following description.

The second power distribution path Pb is connected to the commercial electric power system CS and provided thereon with an electric energy meter M. The electric energy meter M is an electric power detector that detects the direction and level of electric power flow, as well as electric energy, in the second power distribution path Pb, and outputs a detection signal representing results of the detection to the PCS 3. For example, when electric power is flowing in the second power distribution path Pb from the power generation system 100a to the commercial electric power system CS, the electric energy meter M detects that the power generation system 100a is selling power to the commercial electric power system CS and also detects the electric energy and level of the exported electric power. When electric power is flowing in the second power distribution path Ph from the commercial electric power system CS to the power generation system 100a and/or to the electric power load system. LS, the electric energy meter M detects that the power generation system 100a is buying power from the commercial electric power system CS and also detects the electric energy and level of the received electric power.

The electric power load system LS is disposed between the first power distribution path Pa and the second power distribution path Pb. The electric power load system. LS includes, for example, load devices such as domestic electrical appliances and factory equipment, and consumes electric power supplied from the first power distribution path Pa and/or the second power distribution path Pb. The electric power that is supplied to, and consumed by, the electric power load system LS may be referred to as the “consumed electric power” in the following description.

The string of solar cells 1 is a power generation device including a plurality of series-connected solar cell modules, and generates DC power under sunlight for output to the PCS 3. The electric power that is outputted from the string of solar cells 1 to the PCS 3 may be referred to as the “generated electric power” in the following description. The number of strings of solar cells 1 in the power generation system 100a is by no means limited to the example shown in FIG. 1 and may be two or greater. As an example, a plurality of parallel-connected strings of solar cells 1 may be connected to the PCS 3 (more specifically, a DC/DC converter 31 which will be described later). In this structure, each of the strings of solar cells 1 may be connected to the PCS 3 via a reverse flow prevention unit that prevents reverse electric current from flowing into that string of solar cells 1. The string of solar cells 1 may include a single solar cell module.

The power storage device 2 is an energy storage device capable of storing in electrical form the electric power generated by the power generation system 100a that is operated in conjunction with the commercial electric power system CS. The power storage device 2 has a charging/discharging function and is capable of being repeatedly charged/discharged. For example, the power storage device 2 is charged by (stores) the DC power supplied from the PCS 3 and discharged delivering (releases) DC power to the PCS 3 in accordance with a charge ratio, i.e., an SOC (state of charge), thereof. An SOC gives a ratio of used capacity to the total charging capacity of the power storage device 2. Throughout the following description, the electric power that is supplied from the PCS 3 to the power storage device 2 during charging will be referred to as the “charging electric power”, and the electric power that is outputted from the power storage device 2 to the PCS 3 during discharging will be referred to as the “discharged electric power.” The power storage device 2 is not limited in its structure in any particular manner. As an example, the power storage device 2 may include a lithium secondary battery, a nickel hydrogen battery, a nickel cadmium battery, a lead battery, and/or any other secondary battery The power storage device 2 may alternatively or additionally include an electric double layer capacitor. The number of power storage devices 2 is by no means limited to the example shown in FIG. 1 and may be two or greater.

The power storage device 2 includes an input/output electric power detection unit 21 that detects the charging/discharging operation (charging, discharging, and suspension of charging/discharging) and operating status of the power storage device 2. As an example, the input/output electric power detection unit 21 detects the charging operation, charging electric power level, discharging operation, discharged electric power level, and suspended charging/discharging of the power storage device 2. Results of this detection are outputted as a status notification signal from the power storage device 2 to the PCS 3. The methods of detecting the charging/discharging operation and operating status of the power storage device 2 is not limited in any particular manner. As an example, the input/output electric power detection unit 21 may detect from changes of the electric current inputted to or outputted from the power storage device 2. When this is actually the case, the input/output electric power detection unit 21 detects the charging/discharging operation of the power storage device 2 based on the direction of the electric current flow between the PCS 3 and the power storage device 2. The input/output electric power detection unit 21 can then detect the charging electric power and discharged electric power levels from, for example, a change in the electric current level and the nominal voltage of the power storage device 2.

The PCS 3 is a control device disposed between the string of solar cells 1, the power storage device 2, and the commercial electric power system CS. The PCS 3, in normal operation, controls the operating voltage (operating point) of the string of solar cells 1 by, for example, MPPT (maximum power point tracking) in such a manner as to achieve maximum power generation. However, when there is a need to restrict the power generation of the string of solar cells 1, the PCS 3 sets the operating voltage of the string of solar cells 1 to a value off a maximum output operating voltage to adjust electric power generation. The PCS 3 also controls the charging/discharging function of the power storage device 2. For example, the PCS 3 operates in such a manner as to supply the power storage device 2 with charging electric power to charge the power storage device 2 and operates in such a manner as to discharge the power storage device 2 to receive the discharged electric power.

The PCS 3 includes the DC/DC converter 31, an inverter 32, a bidirectional DC/DC converter 33, a smoothing capacitor 34, a communication unit 35, a memory unit 36, and a CPU (central processing unit) 37. The DC/DC converter 31, the inverter 32, and the bidirectional DC/DC converter 33 are mutually connected via a bus line BL.

The DC/DC converter 31, disposed between the string of solar cells 1 and the bus line BL, converts the electric power generated by the string of solar cells 1 to DC power of a predetermined voltage value for output to the bus line BL. The DC/DC converter 31 serves also as a reverse flow prevention unit that prevents reverse electric current from flowing into the string of solar cells 1.

The inverter 32 is a power conversion unit controlled by the CPU 37 and disposed between the bus line BL and the first power distribution path Pa. The inverter 32 is capable of the unidirectional electric power conversion illustrated in FIG. 1, for example, by PWM (pulse width modulation) or by PAM (pulse amplitude modulation). In other words, the inverter 32 DC/AC-converts the DC power inputted from the bus line BL (either one or both of the generated electric power and the electric power discharged from the power storage device 2) to AC-frequency AC power in accordance with electric power specifications for the commercial electric power system CS and the electric power load system LS for output to the first power distribution path Pa. The electric power conversion by the inverter 32 of the electric power supplied from the bus line BL for output to the first power distribution path Pa will be referred to as the “electric power conversion in reverse conversion direction b” in the following description. In addition, the electric power conversion in reverse conversion direction b will be referred to as the “reverse conversion,” and the quantity of the electric power subjected to the reverse conversion will be referred to as the “reverse conversion quantity.”

The bidirectional DC/DC converter 33, disposed between the bus line BL and the power storage device 2, is a charging/discharging electric power conversion unit controlled by the CPU 37. The bidirectional DC/DC converter 33 DC/DC-converts the DC power inputted from the bus line BL to DC charging electric power that is suited to the power storage device 2 for output to the power storage device 2. The bidirectional DC/DC converter 33 also DC/DC-converts the electric power discharged from the power storage device 2 to an electric power in accordance with the specifications of the inverter 32 for output to the bus line BL. In the following description, the electric power conversion by the bidirectional DC/DC converter 33 of the electric power inputted from the bus line BL for output to the power storage device 2 will be referred to as the “electric power conversion in charging direction A,” this electric power conversion in charging direction A will be referred to as the “charging conversion,” and the quantity of the electric power subjected to the charging conversion will be referred to as the “charging conversion quantity.” Additionally, the electric power conversion by the bidirectional DC/DC converter 33 of the electric power discharged from the power storage device 2 for output to the bus line BL will be referred to as the “electric power conversion in discharging direction B.” Electric power conversion in discharging direction B will be referred to as “discharging conversion,” and the quantity of electric power subjected to the discharging conversion will be referred to as the “discharging conversion quantity.”

The smoothing capacitor 34 is connected to the bus line BL to remove or reduce variations in the bus voltage value of the electric power flowing in the bus line BL.

The communication unit 35 is a communication interface for communication with a controller 4 over a wireless or wired link.

The memory unit 36 is a storage medium for retaining stored information in a non-volatile manner without having to supply electric power. The memory unit 36 stores, among others, control information and programs used in various elements (in particular, the CPU 37) of the PCS 3. As an example, the memory unit 36 stores target value information, power generation variation factor information, output restriction information, power demand information, and electricity price information.

The target value information includes, for example, an SOC target value for the power storage device 2 for each time period of each day and an updating date and time for the target value information. These target values will be referred to as the “target SOCs” in the following description. The power generation variation factor information includes, for example, information on factors for day-to-day and period-to-period variations of the electric power generated by the string of solar cells 1 (e.g., calendrical information and weather information). The calendrical information includes calendar-related information, specifically, day-to-day sunrise and sunset times at the location where the string of solar cells 1 is installed, as an example. The weather information includes a weather forecast for each time period of each day for the geographical region in and around the location where the string of solar cells 1 is installed.

The output restriction information is normally given in advance from an electric power supply business operator (e.g., electric power company) that runs and manages the commercial electric power system CS. The output restriction information includes the presence/absence of an output-restricting period. An output-restricting period is a period during which the exported electric power sold from the power generation system 100a to the commercial electric power system CS is restricted (subjected to output restriction). The output restriction information, if indicating the presence of an output-restricting period, further includes an output-restricting period (a date and time and a period of the day) and the specifics of the output restriction in an associated manner, so that the PCS 3 can perform the output restriction in accordance with the specifics associated with the output-restricting period. If the output restriction information does not indicate an output-restricting period, the PCS 3 does not perform output restriction. The output-restricting period encompasses a disconnection period during which the power generation system 100a is disconnected from the commercial electric power system CS. The output restriction information may be obtained, for example, from a server of an electric power supply business operator over a network NT and may be specified in response to a user input in a suitable manner at an arbitrary timing.

The power demand information gives a predicted power consumption of the electric power load system LS for each period of the day. The predicted power consumption is a value predicted from the power consumption history of the electric power load system LS. The electricity price information gives period-to-period prices of the electric power bought from the commercial electric power system CS or of the electric power sold to the commercial electric power system CS.

The CPU 37 is a computer unit that controls various elements of the PCS 3 using, for example, control information and programs stored in the memory unit 36. The CPU 37 includes, as functional elements, a power monitoring unit 371, a power storage monitoring unit 372, a conversion control unit 373, a timer 374, an information obtaining unit 375, and a target setting unit 376.

The power monitoring unit 371 monitors the electric power flowing in the second power distribution path Pb (i.e., the exported electric power and the received electric power). As an example, the power monitoring unit 371 detects the direction, electric energy, and electric power level of electric power flow in the second power distribution path Pb based on a detection signal outputted from the electric energy meter M. The power monitoring unit 371 also calculates the period-to-period power consumption of the electric power load system LS based on these detection results and saves results of the calculation in association with a date and time (i.e., date and period of the day) as part of the power demand information.

The power monitoring unit 371 functions also as a power generation prediction unit that predicts the electric power generated by the string of solar cells 1 for each period of the day based on information stored in the memory unit 36 (e.g., power generation variation factor information, power demand information, and electricity price information).

The power storage monitoring unit 372 monitors the operating status of the power storage device 2. For example, the power storage monitoring unit 372 detects the operating status of the power storage device 2 based on a status notification signal outputted from the power storage device 2. The operating status of the power storage device 2 includes the total charging capacity, used capacity (or SOC), and charging/discharging state (e.g., the charging operation, charging electric power level, discharging operation, discharged electric power level, and suspended charging/discharging) of the power storage device 2.

The conversion control unit 373 controls the DC/DC converter 31, the inverter 32, and the bidirectional DC/DC converter 33. As an example, the conversion control unit 373 detects and controls electric power conversion operations of the DC/DC converter 31, the inverter 32, and the bidirectional DC/DC converter 33 based on, for example, the operating status of the power generation system 100a (e.g., whether the power generation system 100a is selling electric power or consuming electric power by itself, and electric power levels in these situations), the operating status of the power storage device 2, the information stored in the memory unit 36, and user inputs. The control of the electric power conversion operations includes switching of electric power conversion directions, adjustment of electric power conversion quantity, and suspension of electric power conversion.

The conversion control unit 373 functions also as a storage control unit that controls the power storage device 2 based on the output restriction information and the prediction made by the power generation prediction unit (i.e., the power monitoring unit 371). Specifically, the conversion control unit 373 controls the charging/discharging function of the power storage device 2 by controlling the DC/DC converter 31, the inverter 32, and the bidirectional DC/DC converter 33. As an example, the conversion control unit 373 causes the power storage device 2 to electrically discharge in a time period that precedes the output-restricting period and to electrically recharge during the output-restricting period.

The timer 374 is a time measuring unit and measures and records the current date and time (i.e., the date and time of the current point in time) and measures the time elapsed from a predetermined point in time to the current point in time.

The information obtaining unit 375 obtains various information (including the calendrical information, weather information, output restriction information, power demand information, and electricity price information) via the controller 4 (detailed later) over the network NT. The calendrical information is available from, for example, a server of the National Astronomical Observatory of Japan. The weather information is available from, for example, a server of Japan Meteorological Agency. The output restriction information and the electricity price information are available from a server of the electric power supply business operator.

The target setting unit 376 determines a target SOC value for each time period of each day based on, for example, the prediction made by the power generation prediction unit (i.e., the power monitoring unit 371) and the information obtained by the information obtaining unit 375, and sets the target SOCs to those values in association with dates and times.

Next, the controller 4 will be described. The controller 4 includes a display unit 41, an input unit 42, a communication unit 43, a communication I/F 44, and a CPU 45. The display unit 41 displays, for example, information on the power generation system 100a on a display device (not shown). The input unit 42 receives user inputs and outputs input signals corresponding to the user inputs to the CPU 45. The communication unit 43 provides a communication interface for the PCS 3 for wired or wireless communication. The communication unit 43 transmits, for example, information on the user inputs received by the input unit 42 to the PCS 3. The communication I/F 44 is a communication interface connected to the network NT (e.g., the Internet). The CPU 45 controls various elements of the controller 4 using, for example, control information and programs stored in a memory (not shown) that stores information in a non-volatile manner.

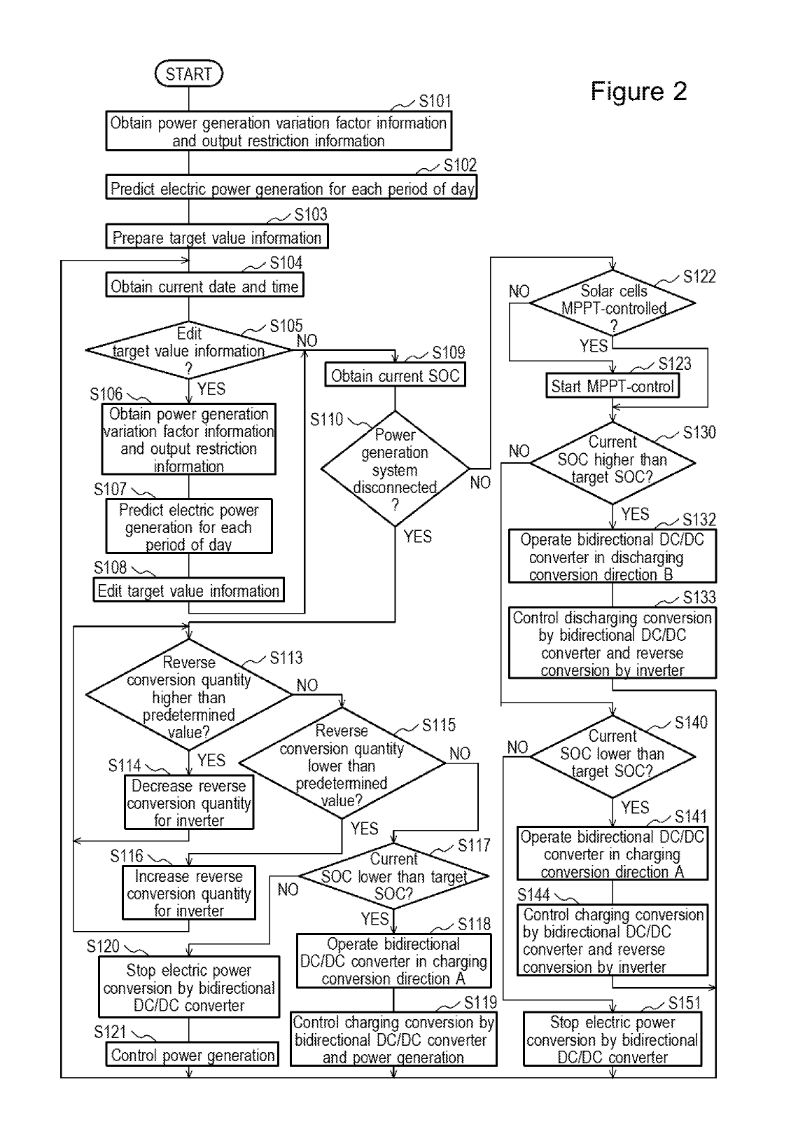

Next, an electric power control method will be described that is implemented by the power generation system 100a of the first configuration example. FIG. 2 is a flow chart depicting an electric power control process in the first configuration example. The following description will disclose an electric power control process implemented on a day for which a disconnection period is planned. In this electric power control process, the operating voltage (operating point) of the string of solar cells 1 is normally controlled in such a manner as to achieve maximum power generation.

The information obtaining unit 375 obtains power generation variation factor information and output restriction information and stores the information in the memory unit 36 (S101). The power generation prediction unit (i.e., the power monitoring unit 371) predicts electric power generated by the string of solar cells 1 for each period of the day based on the power generation variation factor information stored in the memory unit 36 (S102). The target setting unit 376 prepares the target value information based on, for example, the prediction made by the power generation prediction unit and the output restriction information (S103). The timer 374 then acquires the current date and time (S104).

Next, the target setting unit 376 determines whether or not to edit the target value information (S105). Specifically, the target setting unit 376 determines whether or not to update a target SOC schedule (settings of period-to-period target SOCs for each day) for the power storage device 2. If the target value information is not to be edited (NO in step S105), the process proceeds to step S109 (detailed later). On the other hand, if the target value information is to be edited (YES in step S105), the information obtaining unit 375 obtains the power generation variation factor information and the output restriction information anew and stores the information in the memory unit 36 (S106). The power generation prediction unit predicts anew electric power generated in each period of the day based on the power generation variation factor information stored in the memory unit 36 (S107). The target setting unit 376 edits the target value information (S108). Then, the process proceeds to step S109.

The power storage monitoring unit 372 obtains the current SOC of the power storage device 2 (S109). It is then determined, based on the current date and time and the output restriction information, whether or not the power generation system 100a is disconnected from the commercial electric power system CS (S110).

If it is determined that the power generation system 100a is disconnected (YES in step S110), the conversion control unit 373 controls the reverse conversion quantity for the inverter 32 to a predetermined value. This predetermined value is higher than the predicted power consumption, and information on the value is stored in the memory unit 36. Specifically, the conversion control unit 373 determines whether or not the reverse conversion quantity achieved by the inverter 32 is higher than the predetermined value (S113). Upon determining that the reverse conversion quantity is higher than the predetermined value (YES in step S113), the conversion control unit 373 decreases the reverse conversion quantity achieved by the inverter 32 (S114). Then, the process returns to step S113. Upon determining that the reverse conversion quantity is not higher than the predetermined value (NO in step S113), the conversion control unit 373 determines whether or not the reverse conversion quantity achieved by the inverter 32 is lower than the predetermined value (S115). Upon determining that the reverse conversion quantity is lower than the predetermined value (YES in step S115), the conversion control unit 373 increases the reverse conversion quantity achieved by the inverter 32 (S116). Then, the process returns to step S113. Upon determining that the reverse conversion quantity is not lower than the predetermined value (NO in step S115), the process proceeds to step S117.

The power storage monitoring unit 372 determines, based on the target value information and the current date and time, whether or not the current SOC is lower than the target SOC (S117). If the power storage monitoring unit 372 determines that the current SOC is lower (YES in step S117), the conversion control unit 373 causes the bidirectional DC/DC converter 33 to operate in charging conversion direction A (S118). Then, charging conversion performed by the bidirectional DC/DC converter 33 is controlled, and power generation performed by the string of solar cells 1 is controlled (S119). Specifically, the conversion control unit 373 controls charging conversion performed by the bidirectional DC/DC converter 33, and the DC/DC converter 31 controls the electric power generated by the string of solar cells 1. For example, the conversion control unit 373 increases the charging conversion quantity achieved by the bidirectional DC/DC converter 33. When the charging conversion quantity reaches a maximum, the operating voltage of the string of solar cells 1 is controlled to lower the generated electric power. Then, the process returns to step S104.

On the other hand, if the power storage monitoring unit 372 determines that the current SOC is not lower (NO in step S117), the conversion control unit 373 stops the charging conversion performed by the bidirectional DC/DC converter 33 so as to stop charging the power storage device 2 (S120). Power generation by the string of solar cells 1 is then controlled (S121). Specifically, the DC/DC converter 31 controls the operating voltage of the string of solar cells 1 to lower the generated electric power. Then, the process returns to step S104.

Next, if it is determined that the power generation system 100a is not disconnected from the commercial electric power system CS (NO in step S110), the conversion control unit 373 first determines whether or not the DC/DC converter 31 is MPPT-controlling the string of solar cells 1 (S122). If it is determined that the DC/DC converter 31 is MPPT-controlling the string of solar cells 1 (YES in step S122), the process proceeds to step S130 (detailed later). On the other hand, if it is determined that the DC/DC converter 31 is not MPPT-controlling the string of solar cells 1 (NO in step S122), the conversion control unit 373 causes the DC/DC converter 31 to MPPT-control the string of solar cells 1 (S123), and the process proceeds to step S130.

The power storage monitoring unit 372 determines, based on the target value information and the current date and time, whether or not the current SOC is higher than the current target SOC (S130). If the power storage monitoring unit 372 determines that the current SOC is higher (YES in step S130), the conversion control unit 373 causes the bidirectional DC/DC converter 33 to operate in discharging conversion direction B (S132). Then, the conversion control unit 373 controls the discharging conversion performed by the bidirectional DC/DC converter 33 and the reverse conversion performed by the inverter 32 to decrease the current SOC (S133). Then, the process returns to step S104.

Upon determining that the current SOC is not higher (NO in step S130), the power storage monitoring unit 372 determines, based on the target value information and the current date and time, whether or not the current SOC is lower than the current target SOC (S140). If the power storage monitoring unit 372 determines that the current SOC is lower (YES in step S140), the conversion control unit 373 causes the bidirectional DC/DC converter 33 to operate in charging conversion direction A (S141). The conversion control unit 373 also controls the charging conversion performed by the bidirectional DC/DC converter 33 and the reverse conversion performed by the inverter 32 based on information stored in the memory unit 36 to increase the current SOC (S144). Then, the process returns to step S104.

If the power storage monitoring unit 372 determines that the current SOC is not lower (NO in step S140), the conversion control unit 373 stops the electric power conversion performed by the bidirectional DC/DC converter 33 (S151). Then, the process returns to step S104.

If a power supply source, other than the power generation system 100a, can supply electric power to the electric power load system LS during a disconnection period in the electric power control process, the predetermined value of the reverse conversion quantity used in S113 to S116 may be lower than the predicted power consumption. For example, if the electric power load system LS is connected to the commercial electric power system CS via a path other than the power distribution path P, the predetermined value may be 0 (kW). Alternatively, in the same situation, the conversion control unit 373 may, instead of executing S113 to S116, stop the electric power conversion performed by the inverter 32 and after the disconnection period ends (when NO in step S110), activate the inverter 32.

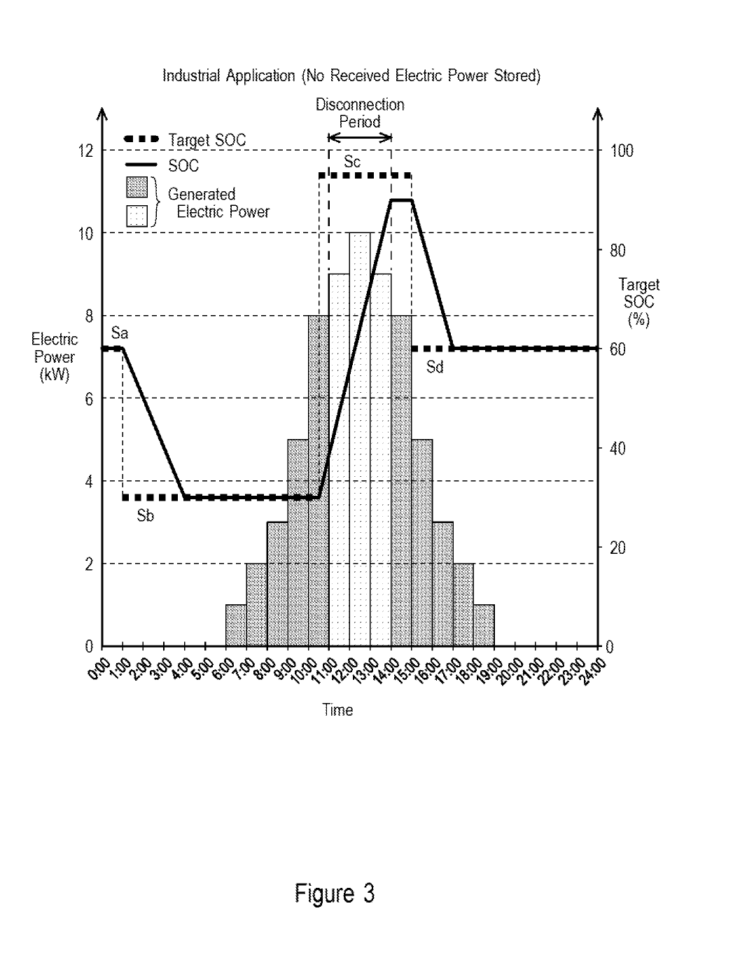

Next, exemplary control of the power storage device 2 will be described in accordance with the present embodiment. FIG. 3 is a graph representing exemplary control of charging/discharging of the power storage device 2 in accordance with the first embodiment. As described above, in the power generation system 100a in accordance with the present embodiment, the power storage device 2 cannot be charged by the received electric power that is bought from the commercial electric power system CS.

In FIG. 3, the sunrise is from 6:00 to 7:00, and the sunset is from 18:00 to 19:00. During the pre-sunrise period from 0:00 to 6:00 and the post-sunset period from 19:00 to 24:00, there is no insolation, and hence no electric power is generated. Insolation generally starts to increase in the sunrise period (6:00 to 7:00), reaches a maximum in the period from 12:00 to 13:00, and thereafter decreases toward the sunset period (18:00 to 19:04). Accordingly, electric power is generated from the sunrise to the sunset, or during the period from 6:00 to 19:00, and reaches a maximum during a peak period from 12:00 to 13:00. During the peak period from 12:00 to 13:00 and immediately before and after that period, however, because distributed power sources other than the power generation system 100a export large quantities of electric power to the commercial electric power system CS, there occurs surplus electric power in the commercial electric power system CS. Therefore, the electric power supply business operator, running and managing the commercial electric power system CS, designates a period from 11:00 to 14:00 encompassing the peak period from 12:00 to 13:00 as a disconnection period. During the disconnection period from 11:00 to 14:00, the power generation system 100a is disconnected from the commercial electric power system CS (i.e., excluded from conjunction operation) to restrict exported electric power.

The target setting unit 376 specifies a target SOC for the power storage device 2 as indicated by a thick broken line in the graph of FIG. 3, to secure empty capacity for electric power in advance so that the power storage device 2 can be charged during the disconnection period from 11:00 to 14:00. As a result, the SOC of the power storage device 2 changes as indicated by a solid line in the graph of FIG. 3. Specifically, the target SOC (Sb) for the period from 1:00 to 10:30 is specified to be sufficiently lower than the target SOC (Sc) for the period from 10:30 to 15:00 encompassing the disconnection period in order to cause the power storage device 2 to discharge, thereby reducing the SOC thereof, before 11:00 when the disconnection period is started. The difference between the two target SOCs (=Sc-Sb) in this situation is preferably greater than or equal to, and more preferably greater than, a value that corresponds to the electric energy that is equal to the electric power predicted to be generated during the period from 10:30 to 15:00 encompassing the disconnection period from 11:00 to 14:00 minus the electric power predicted to be consumed. This arrangement enables the power storage device 2 to store an equivalent of that electric energy. This in turn eases restrictions on electric power generation during the disconnection period from 11:00 to 14:00, thereby achieving efficient power generation. The total daily electric power generation can be increased by effectually using the electric power generated during the disconnection period from 11:00 to 14:00.

More specifically, referring to FIG. 3, the target SOC of the period from 0:00 to 1:00 is set to target value Sa (e.g., Sa=60%). Since the SOC meets the target SOC, the power storage device 2 is neither charged nor discharged.

During the period from 1:00 to 10:30, the target SOC is set to target value Sb (e.g., Sb=30%) that is lower than target value Sa, to cause the power storage device 2 to discharge in preparation for charging that takes place during the disconnection period from 11:00 to 14:00. Therefore, the power storage device 2 is discharged until the SOC reaches target value Sb, after which the power storage device 2 stops the charging/discharging operation thereof.

The target SOC is set to target value Sc (e.g., Sc=95%) that is higher than target value Sb during the period from 10:30 to 15:00 encompassing the disconnection period from 11:00 to 14:00. The reverse conversion quantity achieved by the inverter 32 is significantly decreased during the period from 10:30 to 14:00, to stop selling electric power in preparation for the disconnection of the power generation system 100a. Therefore, during the same period, the power storage device 2 is supplied with surplus electric power that is equal to the generated electric power minus a predetermined electric power (e.g., consumed electric power). The power storage device 2 is charged by this surplus electric power. In contrast, subsequent to the disconnection period from 11:00 to 14:00, the power generation system 100a is operated in conjunction with the commercial electric power system CS (i.e., the power generation system 100a is reconnected to the commercial electric power system CS), thereby becoming capable of selling electric power. The reverse conversion quantity achieved by the inverter 32 is therefore significantly increased during the period from 14:00 to 15:00. That leaves substantially no surplus electric power, so that the power storage device 2 is not charged and the SOC does not increase.

During the period from 15:00 to 24:00, the target SOC is set to target value Sd (e.g., Sd=60%) that is lower than target value Sc, to cause the power storage device 2 to discharge, but leave some backup electric power retained in the power storage device 2. Therefore, the power storage device 2 discharges until the SOC reaches target value Sd, after which the power storage device 2 stops the charging/discharging operation thereof. The present embodiment is not configured such that the power storage device 2 can be charged by received electric power; therefore, the backup electric power is specified to be greater in the present embodiment than in a configuration in which the power storage device 2 can be charged by received electric power.

### Second Embodiment

Next, a second embodiment will be described. The description below will focus on configurational differences from the first embodiment. Those elements which are substantially similar to the corresponding elements in the first embodiment will be given the same reference numerals, and their description may be omitted.

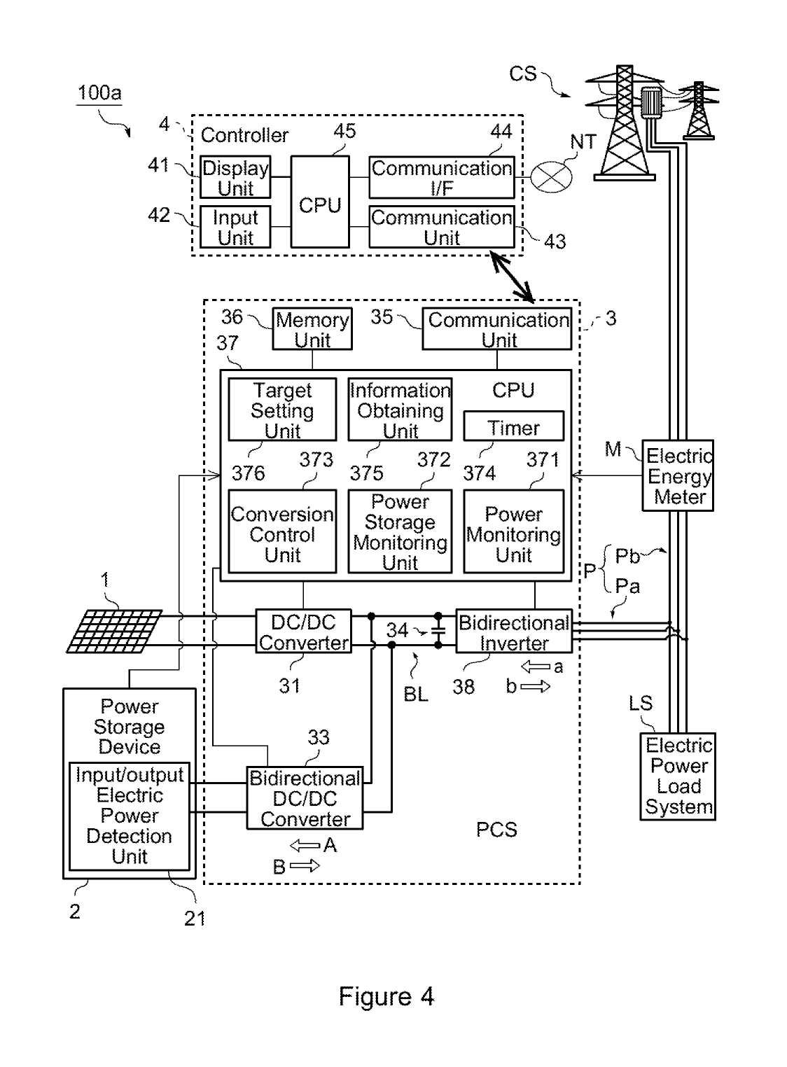

FIG. 4 is a block diagram of a second configuration example of the power generation system 100a. The power generation system 100a is a power generation facility used as a distributed industrial power source and capable of converting the AC power received from the commercial electric power system CS via the power distribution path P to DC power to charge the power storage device 2.

In this power generation system 100a of the second configuration example, the PCS 3 includes a bidirectional inverter 38 as well as the elements 31 and 33 to 37 that are also provided in the first configuration example (FIG. 1). The bidirectional inverter 38 is connected mutually to the DC/DC converter 31 and the bidirectional DC/DC converter 33 via the bus line BL.

The bidirectional inverter 38, disposed between the bus line BL and the first power distribution path Pa, is a power conversion unit controlled by the CPU 37. The bidirectional inverter 38 is capable of the bidirectional electric power conversion illustrated in FIG. 4, for example, by PWM or by PAM. For example, the bidirectional inverter 38, as well as being capable of reverse conversion (electric power conversion in reverse conversion direction b), AC/DC-converts the AC power inputted from the first power distribution path Pa to DC power for output to the bus line BL. The electric power conversion by the bidirectional inverter 38 of the electric power inputted from the first power distribution path Pa for output to the bus line BL will be referred to as the “electric power conversion in forward conversion direction a” in the following description. In addition, the electric power conversion in forward conversion direction a will be referred to as the “forward conversion,” and the quantity of the electric power subjected to the forward conversion will be referred to as the “forward conversion quantity.”

The bidirectional inverter 38 is controlled by the conversion control unit 373. As an example, the conversion control unit 373 detects and controls electric power conversion operations of the bidirectional inverter 38 based on, for example, the operating status of the power generation system 100a whether the power generation system 100a is selling/buying electric power or consuming electric power by itself, and electric power levels in these situations), the operating status of the power storage device 2, and user inputs.

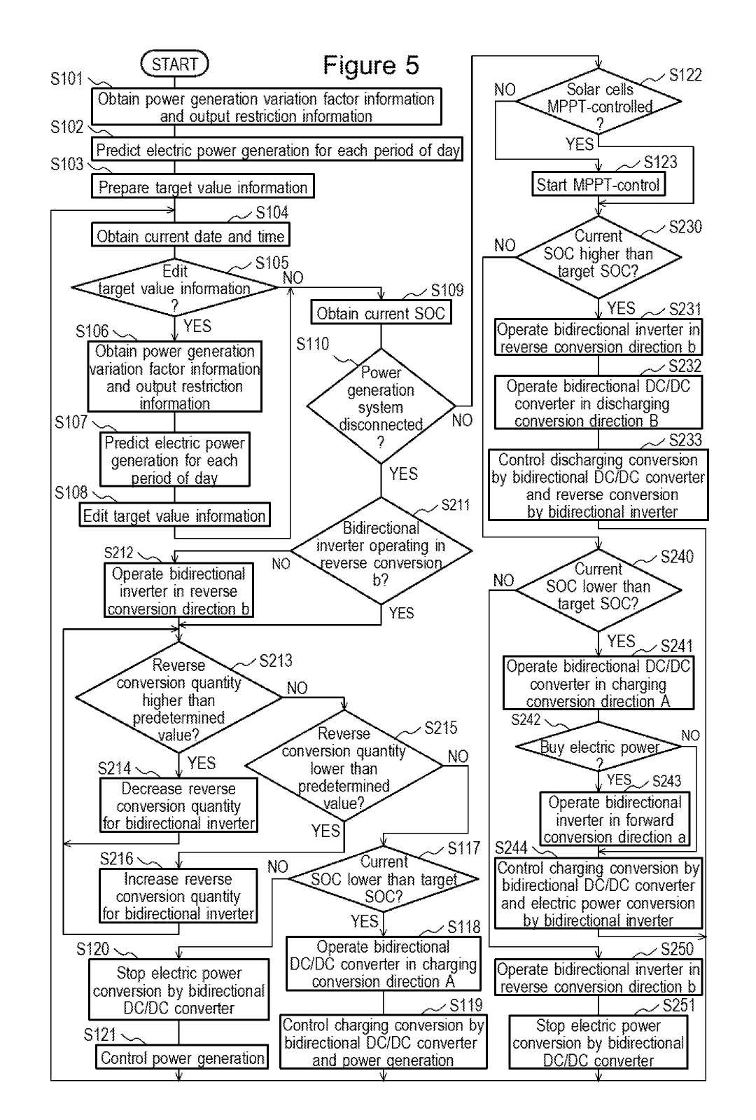

Next, an electric power control method will be described that is implemented by the power generation system 100a of the second configuration example. FIG. 5 is a flow chart depicting an electric power control process in the second configuration example. The following description will disclose an electric power control process implemented on a day for which a disconnection period is planned. In this electric power control process, the operating voltage (operating point) of the string of solar cells 1 is normally controlled in such a manner as to achieve maximum power generation.

The steps from S101 to S110 here are the same as the corresponding steps in the electric power control process in the first configuration example (see FIG. 2). Description of these steps is therefore omitted.

If it is determined that the power generation system 100a is disconnected from the commercial electric power system CS (YES in step S110), the conversion control unit 373 controls the reverse conversion quantity for the bidirectional inverter 38 to a predetermined value. This predetermined value is higher than the predicted power consumption, and information on the value is stored in the memory unit 36. Specifically, the conversion control unit 373 determines whether or not the bidirectional inverter 38 is operating in reverse conversion direction b (S211). Upon determining that the bidirectional inverter 38 is operating in reverse conversion direction b (YES in step S211), the process proceeds to step S213 (detailed later). Upon determining that the bidirectional inverter 38 is not operating in reverse conversion direction b (NO in step S211), the conversion control unit 373 causes the bidirectional inverter 38 to operate in reverse conversion direction b (S212). Then, the process proceeds to step S213 (detailed later).

The conversion control unit 373 determines whether or not the reverse conversion quantity achieved by the bidirectional inverter 38 is higher than the predetermined value (S213). Upon determining that the reverse conversion quantity is higher than the predetermined value (YES in step S213), the conversion control unit 373 decreases the reverse conversion quantity achieved by the bidirectional inverter 38 (S214). Then, the process returns to step S213, Upon determining that the reverse conversion quantity is not higher than the predetermined value (NO in step S213), the conversion control unit 373 determines whether or not the reverse conversion quantity achieved by the bidirectional inverter 38 is lower than the predetermined value (S215). Upon determining that the reverse conversion quantity is lower than the predetermined value (YES in step S215), the conversion control unit 373 increases the reverse conversion quantity achieved by the bidirectional inverter 38 (S216). Then, the process returns to step S213. Upon determining that the reverse conversion quantity is not lower than the predetermined value (NO in step S215), S117 to S121 are performed in the same manner as in the electric power control process in the first configuration example (see FIG. 2), after which the process returns to step S104.

Next, if it is determined that the power generation system 100a is not disconnected from the commercial electric power system CS (NO in step S110), the conversion control unit 373 first determines whether or not the DC/DC converter 31 is MPPT-controlling the string of solar cells 1 (S122). If it is determined that the DC/DC converter 31 is MPPT-controlling the string of solar cells 1 (YES in step S122), the process proceeds to step S230. On the other hand, if it is determined that the DC/DC converter 31 is not MPPT-controlling the string of solar cells 1 (NO in step S122), the conversion control unit 373 causes the DC/DC converter 31 to MPPT-control the string of solar cells 1 (S123), and the process proceeds to step S230.

The power storage monitoring unit 372 determines, based on the target value information and the current date and time, whether or not the current SOC is higher than the target SOC (S230). If the power storage monitoring unit 372 determines that the current SOC is higher (YES in step S230), the conversion control unit 373 causes the bidirectional inverter 38 to operate in reverse conversion direction b (S231) and causes the bidirectional DC/DC converter 33 to operate in discharging conversion direction B (S232). Then, the conversion control unit 373 controls the discharging conversion performed by the bidirectional DC/DC converter 33 and the reverse conversion performed by the bidirectional inverter 38 to decrease the current SOC (S233). Then, the process returns to step S104.

Upon determining that the current SOC is not higher (NO in step S230), the power storage monitoring unit 372 determines, based on the target value information and the current date and time, whether or not the current SOC is lower than the current target SOC (S240). If the power storage monitoring unit 372 determines that the current SOC is lower (YES in step S240), the conversion control unit 373 causes the bidirectional DC/DC converter 33 to operate in charging conversion direction A (S241). The conversion control unit 373 also determines whether or not to buy electric power based on information (e.g., electric power price information) stored in the memory unit 36 (S242). Upon determining not to buy electric power (NO in step S242), the process proceeds to step S244 (detailed later). Upon determining to buy electric power (YES in step S242), the conversion control unit 373 causes the bidirectional inverter 38 to operate in forward conversion direction a (S243). Then, the process proceeds to step S244.

The conversion control unit 373 controls the charging conversion performed by the bidirectional DC/DC converter 33 and the electric power conversion performed by the bidirectional inverter 38 based on information stored in the memory unit 36 to increase the current SOC (S244). Then, the process returns to step S104.

If the power storage monitoring unit 372 determines that the current SOC is not lower (NO in step S240), the conversion control unit 373 causes the bidirectional inverter 38 to operate in reverse conversion direction b (S250) and stops the electric power conversion performed by the bidirectional DC/DC converter 33 (S251). Then, the process returns to step S104.

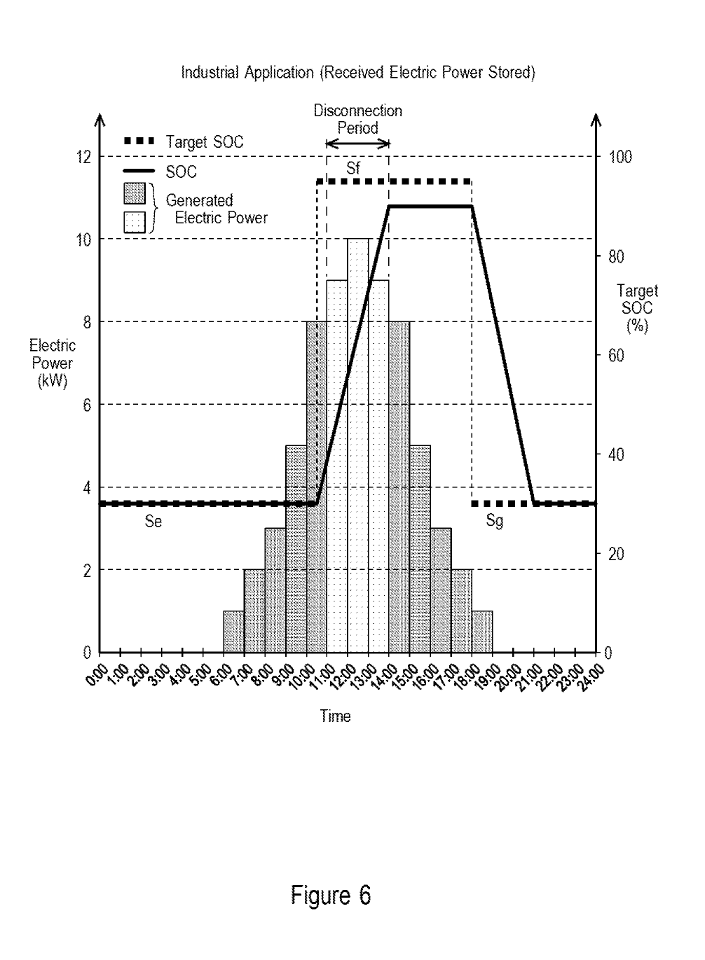

Next, exemplary control of the power storage device 2 will be described in accordance with the present embodiment. FIG. 6 is a graph representing exemplary control of charging/discharging of the power storage device 2 in accordance with the second embodiment. As described above, in the power generation system 100a in accordance with the present embodiment, the power storage device 2 can be charged by the received electric power that is bought from the commercial electric power system CS. The distribution of generated electric power and the disconnection period in FIG. 6 are the same as in the first embodiment (see FIG. 3).

The target setting unit 376 specifies a target SOC for the power storage device 2 as indicated by a thick broken line in the graph of FIG. 6, to secure empty capacity for electric power in advance so that the power storage device 2 can be charged during the disconnection period from 11:00 to 14:00. As a result, the SOC of the power storage device 2 changes as indicated by a solid line in the graph of FIG. 6. Specifically, the target SOC (Se) for the period from 0:00 to 10:30 is specified to be sufficiently lower than the target SOC (St) for the period from 10:30 to 18:00 encompassing the disconnection period in order to cause the power storage device 2 to discharge, thereby reducing the SOC thereof, before 11:00 when the disconnection period is started. The difference between the two target SOCs (Sf-Se) in this situations preferably greater than or equal to, and more preferably greater than, a value that corresponds to the electric energy that is equal to the electric power predicted to be generated during the period from 10:30 to 18:00 encompassing the disconnection period from 11:00 to 14:00 minus the electric power predicted to be consumed. This arrangement enables the power storage device 2 to store an equivalent of that electric energy. This in turn eases restrictions on electric power generation during the disconnection period from 11:00 to 14:00, thereby achieving efficient power generation. The total daily electric power generation can be increased by effectually using the electric power generated during the disconnection period from 11:00 to 14:00.

More specifically, referring to FIG. 6, the target SOC is set to target value Se (e.g., Se=30%) during the period from 0:00 to 10:30, to cause the power storage device 2 to discharge in preparation for charging that takes place during the disconnection period from 11:00 to 14:00. Because the target SOC is already equal to target value Se at 0:00, the power storage device 2 performs no charging/discharging operation.

The target SOC is set to target value Sf (e.g., Sf=95%) that is higher than target value Se during the period from 10:30 to 18:00 encompassing the disconnection period from 11:00 to 14:00. The reverse conversion quantity achieved by the inverter 32 is significantly decreased during the period from 10:30 to 14:00, to stop selling electric power in preparation for the disconnection of the power generation system 100a. Therefore, during the same period, the power storage device 2 is supplied with surplus electric power that is equal to the generated electric power minus a predetermined electric power (e.g., consumed electric power). The power storage device 2 is charged by this surplus electric power. In contrast, subsequent to the disconnection period from 11:00 to 14:00, the power generation system 100a is operated in conjunction with the commercial electric power system CS (i.e., the power generation system 100a is reconnected to the commercial electric power system CS), thereby becoming capable of selling electric power. The reverse conversion quantity achieved by the inverter 32 is therefore significantly increased during the period from 14:00 to 18:00. That leaves substantially no surplus electric power, so that the power storage device 2 is not charged and the SOC does not increase.

During the period from 18:00 to 24:00, the target SOC is set to target value Sg (e.g., Sd=30%) that is lower than target value Sf, to cause the power storage device 2 to discharge, but leave some backup electric power retained in the power storage device 2. Therefore, the power storage device 2 discharges until the SOC reaches target value Sg, after which the power storage device 2 stops the charging/discharging operation thereof. The present embodiment is configured such that the power storage device 2 can be charged by received electric power; therefore, the backup electric power is specified to be lower in the present embodiment than in a configuration in which the power storage device 2 cannot be charged by received electric power.

### Third Embodiment

Next, a third embodiment will be described. The description below will focus on configurational differences from the first and second embodiments. Those elements which are substantially similar to the corresponding elements in the first and second embodiments will be given the same reference numerals, and their description may be omitted.

The power generation system 100a in the third embodiment is a power generation facility used as a distributed domestic power source and capable of converting the AC power received from the commercial electric power system CS via the power distribution path P to DC power to charge the power storage device 2. The configuration of the power generation system 100a and the electric power control method implemented by the power generation system 100a in the third embodiment are the same as in the second embodiment (see FIGS. 4 and 5).

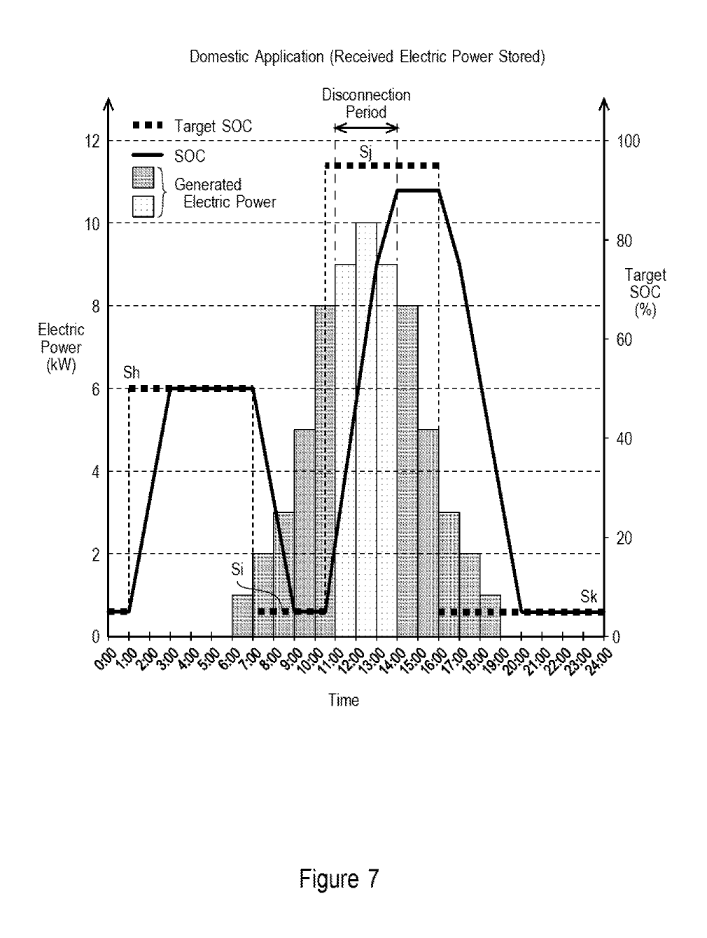

Exemplary control of the power storage device 2 will be described in accordance with the present embodiment. FIG. 7 is a graph representing exemplary control of charging/discharging of the power storage device 2 in accordance with the third embodiment. The distribution of generated electric power and the disconnection period in FIG. 7 are the same as in the first and second embodiments (see FIGS. 3 and 6).

Electric power price varies from one period of the day to another in buying electric power from the commercial electric power system CS. For example, price is cheaper at night when there is relatively low power demand (e.g., before 7:00 and after 23:00) than during the daytime. Therefore, electric power is stored beforehand at night (during the period from 0:00 to 7:00), so that the power demand by the electric power load system LS can be met until the disconnection period is started (e.g., during the period from 7:00 to 10:00). Additionally, the SOC of the power storage device 2 is sufficiently decreased during a period prior to 11:00 when the disconnection period is started, so as to secure empty capacity for electric power that can be filled later during the disconnection period from 11:00 to 13:00. Therefore, the target setting unit 376 specifies a target SOC for the power storage device 2 as indicated by a thick broken line in the graph of FIG. 7. As a result, the SOC of the power storage device 2 changes as indicated by a solid line in the graph of FIG. 7.

Specifically, the target SOC (Sh) for the period from 0:00 to 7:00 is specified to be higher than the target SOC (Si) for the period from 7:00 to 10:30. Additionally, the target SOC (Si) for the period from 7:00 to 10:30 is specified to be sufficiently lower than the target SOC (Sg) for the period from 10:00 to 16:00 encompassing the disconnection period. The difference between the two target SOCs (Sj-Si) in this situation is preferably greater than or equal to a value that corresponds to the electric energy that is equal to the electric power generated during the disconnection period from 11:00 to 14:00 minus the power consumption. This arrangement enables the power storage device 2 to store an equivalent of that electric energy. Therefore, the string of solar cells 1 does not lose an opportunity to generate power during the disconnection period from 11:00 to 14:00, thereby achieving efficient power generation. The total daily electric power generation can be increased by effectually using the electric power generated during the disconnection period from 11:00 to 14:00.

More specifically, referring to FIG. 7, the target SOC is set to target value Sh (e.g., Sh=50%) during the period from 0:00 to 7:00, such that the power storage device 2 stores sufficient electric power to meet power demand during the period from 7:00 to 10:30 that precedes the disconnection period. Therefore, the power storage device 2 discharges until the SOC reaches target value Sh, after which the power storage device 2 stops the charging/discharging operation thereof.

At 7:00, electric power buying price becomes more expensive than at night. Therefore, the target SOC is set to target value Si (e.g., Si=5%) to maintain low electricity price during the period from 7:00 to 10:30 and also to cause the power storage device 2 to discharge in preparation for charging that takes place during the disconnection period from 11:00 to 14:00. Therefore, the power storage device 2 discharges until the SOC reaches target value Si, after which the power storage device 2 stops the charging/discharging operation thereof.

The target SOC is set to target value Sj (e.g., Sj=95%) that is higher than target value Si during the period from 10:30 to 16:00 encompassing the disconnection period from 11:00 to 14:00. The reverse conversion quantity achieved by the inverter 32 is significantly decreased during the period from 10:30 to 14:00, to stop selling electric power in preparation for the disconnection of the power generation system 100a. Therefore, during the same period, the power storage device 2 is supplied with surplus electric power that is equal to the generated electric power minus a predetermined electric power (e.g., consumed electric power). The power storage device 2 is charged by this surplus electric power. In contrast, subsequent to the disconnection period from 11:00 to 14:00, the power generation system 100a is operated in conjunction with the commercial electric power system CS (i.e., the power generation system 100a is reconnected to the commercial electric power system CS), thereby becoming capable of selling electric power. The reverse conversion quantity achieved by the inverter 32 is therefore significantly increased during the period from 14:00 to 16:00. That leaves substantially no surplus electric power, so that the power storage device 2 is not charged and the SOC does not increase.

During the period from 16:00 to 24:00, the target SOC is set to target value Sk (e.g., Sd=5%) that is lower than target value Sj, to cause the power storage device 2 to discharge, but leave some backup electric power retained in the power storage device 2. Therefore, the power storage device 2 discharges until the SOC reaches target value Sk, after which the power storage device 2 stops the charging/discharging operation thereof. The present embodiment is configured such that the power storage device 2 can be charged by received electric power. The present embodiment is also intended for domestic use and hardly needs to leave backup electric power, for example, in preparation for power failure during the Therefore, the backup electric power is specified to be lower in the present embodiment than in an industrial configuration in which the power storage device 2 cannot be charged by received electric power.

### Overview of First to Third Embodiments

The first to third embodiments detailed above give the power storage device 2 as an example of an energy storage device. The present invention is however by no means limited to this illustrative example. Alternatively, the energy storage device may be a device or facility that is capable of converting the electric power supplied from the PCS 3 to a predetermined different form to store the power therein (e.g., thermal, mechanical, or chemical storage). For example, the energy storage device may be a hot water tank, a flywheel battery, or a hydrogen generation and storage device. A hot water tank can supply hot water by using the heat produced by conversion. A flywheel battery converts electric energy to kinetic energy for storage and generates electric power back from kinetic energy to supply electric power. A hydrogen generation and storage device produces hydrogen, for example, by electrolysis of water for storage and later use as an energy source and generates electric power back from stored hydrogen in fuel cells to supply electric power.

In the first to third embodiments detailed above, the conversion control unit 373, when serving as a storage control unit, controls the power storage device 2 based on target value information, power generation variation factor information, and output restriction information. The present invention is however by no means limited to this illustrative example. Alternatively, the conversion control unit 373 may control the power storage device 2 based on either one or both of power demand information and electricity price information, as well as on target value information, power generation variation factor information, and output restriction information.

The electric power control methods disclosed in the first to third embodiments detailed above (see FIGS. 2 and 5) are performed based on target SOCs contained in the target value information. The present invention is however by no means limited to this illustrative example. Alternatively, the electric power control may be implemented based on target SOCs and charging/discharging rates contained in the target value information. Namely, the electric power control may be implemented so that the current SOC reaches the target SOC at a charging or discharging rate contained in the target value information. This arrangement prevents rapid charging and discharging, thereby restricting or preventing, for example, degradation of, and damage to, the power storage device 2.

The first to third embodiments detailed above give a disconnection period as an output-restricting period included in the output restriction information in the exemplary control of charging/discharging of the power storage device 2 (see FIGS. 3, 6, and 7). The present invention is however by no means limited to this illustrative example. The electric power stored in the power storage device 2 during the output-restricting period can be increased by similarly controlling the charging/discharging during any period other than the disconnection period during which the electric power exported to the commercial electric power system CS is restricted. Therefore, the total daily electric power generation can be increased by effectually using the electric power generated during the output-restricting period.

The first to third embodiments detailed above utilize the string of solar cells 1 as a power generation device. The power generation device is however by no means limited to this illustrative example. Alternatively, the power generation device may be one that generates electric power by relying on waste power generation or renewable energy other than the sunlight, such as wind power, water current, geothermal heat, biomass, or solar energy.

In the first to third embodiments detailed above, the power distribution path P is connected to the commercial electric power system CS. Alternatively, the power distribution path P1 may be connected to any AC power source other than the commercial electric power system CS. For example, the power distribution path P1 may be connected to another power generation facility.

In the first to third embodiments detailed above, the functional elements 371 to 376 of the CPU 37 may be at least partly or entirely implemented by physical elements (e.g., electric circuits, devices, and components).

The first to third embodiments detailed above give the PCS 3 in the power generation system 100a as an example to describe the present invention. The present invention is however by no means limited to this illustrative example. The present invention has broad applications in devices that control the charging/discharging function of the power storage device 2.

The first to third embodiments detailed above are directed to a control device 3 controlling an energy storage device 2 capable of storing, in a predetermined form, electric power generated in a power generation facility 100a that is operated in conjunction with an electric power system CS. The control device 3 includes: a power generation prediction unit 371 predicting how much electric power is generated by a power generation device 1 in the power generation facility 100a in each time period of a day based on power generation variation factor information; and a storage control unit 373 controlling the energy storage device 2 based on the prediction made by the power generation prediction unit and the output restriction information. The power generation variation factor information includes information on a factor for day-to-day and period-to-period variations of the generated electric power. The output restriction information contains an output-restricting period during which electric power outputted from the power generation facility 100a to the electric power system CS is restricted. The storage control unit 373 controls the energy storage device 2 to discharge energy stored therein in the predetermined form before the output-restricting period and also to store the generated electric power in the predetermined form during the output-restricting period.

The first to third embodiments detailed above are directed also to a storage medium 36 that, containing a control program in a non-volatile manner, is readable by a computer 37. This control program causes the computer 37 to implement a process of controlling an energy storage device 2 capable of storing, in a predetermined form, electric power generated in a power generation facility 100a that is operated in conjunction with the electric power system CS. The process includes: the step of predicting electric power generated in each time period of a day based on power generation variation factor information including information on a factor for period-to-period variations of the electric power generated by a power generation device 1 in the power generation facility 100a; and the step of controlling the energy storage device 2 based on the prediction obtained in the predicting step and output restriction information on an output-restricting period (e.g., disconnection period) during which electric power outputted from the power generation facility 100a to the electric power system CS is restricted. The step of controlling the energy storage device 2 includes: the substep of causing the energy storage device 2 to discharge energy stored therein in a predetermined form in a period of the day that precedes the output-restricting period; and the substep of storing the generated electric power in the energy storage device 2 during the output-restricting period in the predetermined form.

In any of these configurations, the energy storage device 2 can discharge the energy having been stored in the predetermined form therein for additional empty storage capacity before the output-restricting period (e.g., disconnection period) and thereafter, during the output-restricting period, store the electric power generated by the power generation device 1 in the predetermined form. The energy storage device 2 is therefore capable of storing more generated electric power than if the energy storage device 2 is not allowed to discharge stored energy in advance. Therefore, power generation does not need to be restricted or suspended during the output-restricting period, and the power generation device 1 can be run efficiently. Therefore, the total daily electric power generation can be increased by effectually using the electric power generated during the output-restricting period.

The control device 3 may further include a target setting unit 376 that sets a target value for stored energy (target SOC) for each time period of the day based on the output restriction information and the prediction made by the power generation prediction unit 371; the storage control unit 373 may control the energy stored in the energy storage device 2 based on the target values for the periods of the day; and the target setting unit 376 may set first target values Sc, Sf, and Sj for a first period of the day encompassing an output-restricting period (e.g., disconnection period) and second target values Sb, Se, and Si for a second period of the day that immediately precedes the first period of the day, second target values Sb, Se, and Si being lower than first target values Sc, Sf, and Sj.

This arrangement enables the energy stored in the energy storage device 2 to be controlled based on the target stored energy value setting (target SOC) for each time period of the day. In addition, the low-value settings of the target values Sb, Se, and Si for the second period of the day that immediately precedes the first period encompassing an output-restricting period (e.g., disconnection period) result in the energy stored in the energy storage device 2 being released in advance, which in turn provides the energy storage device 2 with an empty storage capacity. The energy storage device 2 is therefore capable of storing more generated electric power during the first period of the day encompassing an output-restricting period than if the energy storage device 2 is not allowed to discharge stored energy in advance.

The control device 3 may be arranged such that the output-restricting period encompasses a disconnection period during which the power generation facility 100a is disconnected from the electric power system CS.

In this arrangement, the energy storage device 2 can discharge the energy having been stored in the predetermined form therein before a disconnection period during which there is an increased quantity of electric power that can be stored in the energy storage device 2 and thereafter, during the disconnection period, store the electric power generated by the power generation device 1. The power generation device 1 is therefore run more efficiently.

The control device 3 may be arranged such that: the storage control unit 373 controls the energy storage device 2 based further on either one or both of power demand information and electricity price information; the power demand information contains predicted period-to-period power consumption of an electric power load LS connected to the power generation facility 100a; and the electricity price information contains a period-to-period price of electric power supplied from the electric power system CS to either one or both of the power generation facility 100a and the electric power load LS.

This arrangement enables the energy storage device 2 to be controlled further using either one or both of the power demand information and the electricity price information. If the energy storage device 2 is controlled further using power demand information, the energy stored in the energy storage device 2 and the electric power discharged from the energy storage device 2 can be controlled by taking into consideration the predicted period-to-period power consumption of the electric power load LS connected to the power generation facility 100a. Therefore, the power generation device 1 can be run more efficiently, and the electric power bought from the electric power system CS (received electric power) and the electric power sold to the electric power system CS (exported electric power) can be more precisely controlled. Meanwhile, if the energy storage device 2 is controlled further using electricity price information, the energy stored in the energy storage device 2 and the electric power discharged from the energy storage device 2 can be controlled by taking into consideration the period-to-period price of electric power bought from the electric power system CS (received electric power). This facilitates control of the price of the electric power bought over the day. For example, the total daily price can be reduced by buying electric power during a time period when the price is low.

The control device 3 may be arranged such that: the power generation device 1 is a solar power generation device 1; and the power generation variation factor information includes calendrical information and weather information including weather forecasts for each time period of a day for the geographical region in and around the location where the power generation device 1 is installed.

This arrangement enables insolation and weather prediction for each time period for each day, thereby efficiently running the solar power generation device 1. Therefore, the total daily electric power generation can be increased by improving the power generation efficiency of the solar power generation device 1.

The control device 3 may be arranged such that the energy storage device 2 can convert the electric power generated in the power generation facility 100a into a non-electric form for storage.

This arrangement enables conversion of electric power from electric energy to a non-electric energy form (e.g., thermal, mechanical, or chemical energy) for storage in the energy storage device 2.

Alternatively or additionally, the control device 3 may be arranged to control the energy storage device 2 capable of storing in a predetermined form the electric power generated in the power generation facility 100a that is operated in conjunction with the electric power system CS and to include: a memory unit 36 that stores power generation variation factor information including information on a factor for period-to-period variations of the generated electric power; a power generation prediction unit 371 that predicts the electric power generated by the power generation device 1 in the power generation facility 100a for each time period of the day based on the power generation variation factor information; and a storage control unit 373 that controls the energy storage device 2 based on the prediction made by the power generation prediction nit 371, wherein: the memory unit 36 further stores output restriction information including the presence/absence of an output-restricting period (e.g., disconnection period) during which the exported electric power outputted from the power generation facility 100a to the electric power system CS is restricted; and if the output restriction information indicates that there exists an output-restricting period, the storage control unit 373 controls the energy storage device 2 to discharge, before the output-restricting period, the energy stored in a predetermined form therein and to store generated electric power in the predetermined form therein with the export of electric power being restricted during the output-restricting period, and if the output restriction information indicates there exists no output-restricting period, the export of electric power is not restricted.

This arrangement, if there is an output-restricting period, enables the energy stored in a predetermined form to be discharged before the output-restricting period (e.g., disconnection period) and subsequently, the electric power generated by the power generation device 1 to be stored in a predetermined form during the output-restricting period during which the export of electric power is restricted. Therefore, more of the generated electric power is stored than if the stored energy is not discharged prior to the output-restricting period. Therefore, for example, there is no need to restrict or suspend power generation during the output-restricting period, and the power generation device 1 can be run efficiently. Therefore, the total daily electric power generation can be increased by effectually using the electric power generated during the output-restricting period.

A control device 3 in accordance with any one of the first to third embodiments may control an energy storage device 2 capable of storing electric power generated in a power generation facility 100a that is operated in conjunction with an electric power system CS, the control device 3 controlling the energy storage device 2 based on output restriction information on an output-restricting period during which electric power outputted from the power generation facility 100a to the electric power system CS is restricted, such that the energy storage device 2 stores the generated electric power during the output-restricting period (first arrangement).

A control device 3 in accordance with any one of the first to third embodiments may control an energy storage device 2 capable of storing electric power generated in a power generation facility 100a that is operated in conjunction with an electric power system CS, the control device 3 controlling the energy storage device 2 based on a prediction of how much electric power is generated by a power generation device 1 in the power generation facility 100a in each time period of a day and also based on output restriction information on an output-restricting period during which electric power outputted from the power generation facility 100a to the electric power system CS is restricted, such that the energy storage device 2 stores the generated electric power during the output-restricting period, the prediction being made based on information on a factor for day-to-day and period-to-period variations of the generated electric power (second arrangement).

The control device 3 in accordance with either the first or second arrangement above may be arranged such that the control device 3 controls a charge level of the energy storage device 2 that the energy storage device 2 exhibits at a start of the output-restricting period (third arrangement).

The control device 3 in accordance with either the first or second arrangement above may be arranged such that the control device 3: sets a target value for energy stored in the energy storage device 2 for each time period of a day based on the output restriction information and on a prediction of how much electric power is generated by a power generation device 1 in each of the time period; controls the stored energy based on the target values for the time periods; and sets a first target value for a first time period of the day that encompasses the output-restricting period and a second target value for a second time period of the day that immediately precedes the first time period of the day, the second target value being lower than the first target value (fourth arrangement).

The control device 3 in accordance with either the first or second arrangement above may be arranged such that the control device 3 controls the energy storage device 2 further based on either power demand information or electricity price information or both, the power demand information containing predicted period-to-period power consumption of an electric power load LS connected to the power generation facility 100a and the electricity price information containing a period-to-period price of electric power supplied from the electric power system CS to either one or both of the power generation facility 100a and the electric power load LS (fifth arrangement).

The control device 3 in accordance with any one of the first to fifth claims above may be arranged such that information on a factor for day-to-day and period-to-period variations of the generated electric power includes calendrical information and weather information containing period-to-period weather forecasts in a geographical region in and around a location where the power generation device 1 is installed (sixth arrangement).

A control device 3 in accordance with any one of the first to third embodiments may control an energy storage device 2 capable of storing electric power generated in a power generation facility 100a that is operated in conjunction with an electric power system CS, the control device 3, if output restriction information on an output-restricting period during which electric power outputted from the power generation facility 100a to the electric power system CS is restricted indicates that there is such an output-restricting period, controlling a charge level of the energy storage device 2 during the output-restricting period based on the output restriction information, such that the charge level is lower than would be if the output restriction information indicated that there was no output-restricting period at that time (seventh arrangement).

A system in accordance with any one of the first to third embodiments may include: a control device 3; and an energy storage device 2, the control device 3 controlling the energy storage device 2 capable of storing electric power generated in a the power generation facility 100a that is operated in conjunction with an electric power system CS, the control device 3 controlling the energy storage device 2 based on output restriction information on an output-restricting period during which electric power outputted from the power generation facility 100a to the electric power system CS is restricted, such that the energy storage device 2 stores the generated electric power during the output-restricting period (eighth arrangement).

A control method in accordance with any one of the first to third embodiments may be executed by a control device 3 controlling an energy storage device 2 capable of storing electric power generated in a power generation facility 100a that is operated in conjunction with an electric power system CS, the method including controlling the energy storage device 2 based on output restriction information on an output-restricting period during which electric power outputted from the power generation facility 100a to the electric power system CS is restricted, such that the energy storage device 2 stores the generated electric power during the output-restricting period (ninth arrangement).

### Fourth Embodiment

Next, a fourth embodiment will be described. In the following description, those elements which are substantially similar to the corresponding elements in the first to third embodiments will be given the same reference numerals, and their description may be omitted.

In the fourth embodiment, electric power is generated from sunlight as a renewable energy source, and there are provided separate inverters for a solar panel 111 and a storage battery 121. Throughout the following description including fifth to seventh embodiments described later, “DC” electric power, voltage, and current will be referred to simply as “DC,” and “AC” electric power, voltage, and current will be referred to simply as “AC.”

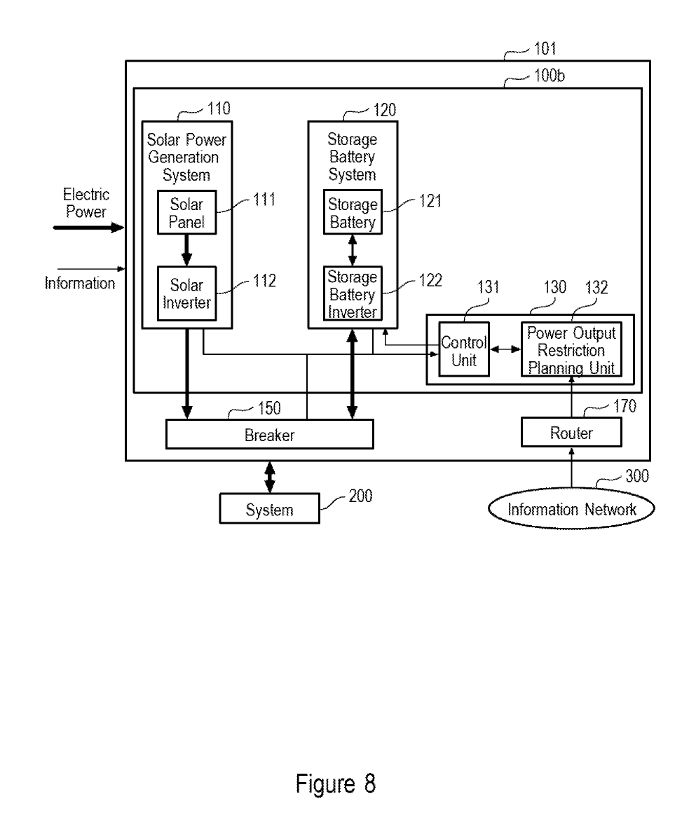

FIG. 8 is a diagram representing an overall configuration of an electric power system including an energy management system 100b in accordance with the fourth embodiment. The energy management system 100b is installed at an installation site 101. Although FIG. 8 illustrates an example of a power plant using, for example, sunlight, the present embodiment is however by no means limited to a power plant. The equipment at the installation site 101 is connected to an external electric power network system 200 and an external information network 300. At the installation site 101 there are provided a breaker 150 and a router 170 as well as the energy management system 100b. The energy management system 100b includes a solar power generation system 110 (electric power generation unit), a storage battery system 120 (storage battery unit), and a computer system 130. In FIG. 8, thick lines indicate main electric power flows, and thin lines indicate information flows. The information network 300 is, for example, the Internet or a dedicated line of an electric power company.

The solar power generation system 110 includes the solar panel 111 for DC power generation and a solar inverter 112 for conversion of DC electric power to AC electric power. The resultant AC electric power goes through the breaker 150 and is outputted to either the system 200 or the storage battery system 120.

The storage battery system 120 includes the storage battery 121 and a storage battery inverter 122. The electric flow between the storage battery 121 and the storage battery inverter 122 is in DC, whereas the electric flow between the storage battery inverter 122 and the breaker 150 is in AC. When the storage battery 121 is charged, AC electric power from the solar power generation system 110 or the system 200 is inputted to the storage battery inverter 122 where it is converted to DC to charge the storage battery 121. When the storage battery 121 is discharged, DC electric power from the storage battery 121 is inputted to the storage battery inverter 122 where it is converted to AC for output to the system 200 via the breaker 150.

The storage battery 121 further includes a portion that actually stores electric power and a portion that manages this storing portion (not shown in FIG. 8). The storage battery 121 is an example of the energy storage device of the present invention. The managing portion manages, for example, an IF (interface) through which the state of the storing portion is obtained, a connection switching IF for interfacing between the storing portion and the outside, the number of times the storage battery 121 has been charged/discharged, and accounting of history. The electric power storing portion may be, for example, a lead battery, an NAS battery, a lithium ion battery, or a hydrogen-based power storage device. A hydrogen-based power storage device decomposes water into hydrogen and oxygen by electrolysis of water using, for example, charging electric power, to collect hydrogen in a container in gas or liquid form. Then, upon discharge, the hydrogen-based power storage device functions as a hydrogen-based fuel cell, thereby generating electric power.

It is the computer system 130 that controls the charging/discharging of the storage battery system 120. The computer system 130 may be, for example, a conventional personal computer or server and may be a dedicated device with computing functions. When the computer system 130 is a dedicated device, the computer system 130 may be incorporated into the storage battery inverter 122. The computer system 130 exchanges information with the solar power generation system 110, the storage battery system 120, the breaker 150, and the router 170.

Information may be classified into information on the electric power and other conditions of a device (electric power/state information), information obtained over the information network 300, and information on instructions given to a device.

Electric power information is obtainable from the solar power generation system 110, the storage battery system 120, and the breaker 150. To this end, each device needs to be equipped with a sensor to obtain this electric power information. The information obtained through measurement using the sensors then can be obtained by the computer system 130 through special interfaces of the solar power generation system 110, the storage battery system 120, and the breaker 150.

Examples of electric power information for the solar power generation system 110 include the DC voltage, current, and power of the solar panel 111 and the AC-side voltage, current, and power of the solar inverter 112.

In the storage battery system 120, the interfaces of the storage battery 121 and the storage battery inverter 122 may be different. When the interface is arranged in a different manner, the electric power/state of the storage battery 121 may be, for example, the remaining empty capacity of the storage battery 121, the switch state of the storage battery 121, and the temperature of the storage battery 121. The electric power/state of the storage battery inverter 122 may be, for example, DC- and AC-side voltages, currents, and powers on charging or discharging, the operating status (charging, discharging, suspension of charging/discharging) of the storage battery, and the state of the switch. When the interface is arranged in a different manner, the storage battery 121 and the storage battery inverter 122 may obtain the same information.

The electric power information for the breaker 150 may be, for example, the electric power bought from or sold to the system 200.

The information obtained over the information network 300 may be, for example, output restriction plan information, predicted output restriction plan information, or weather information for predicting output restriction, obtained from an electric power company. The output restriction plan information obtained from the electric power company is inputted to a power output restriction planning unit 132 in the computer system 130 (energy management device) from the information network 300 via the router 170. A control unit 131 obtains output restriction plan information from the power output restriction planning unit 132. Output restriction plan information may be, for example, a notice only of the presence of a restriction (in such a case, the restriction time period and restricted electric power is agreed upon in advance with the electric power company), a restriction time period (restriction period), or restricted electric power. Restricted electric power may be, for example, complete prohibition where solar-generated electric power is not at all exported to the system 200 or upper limit restriction where solar-generated electric power is allowed to be exported to the system 200. Predicted output restriction plan information may be either obtained over the information network 300 or calculated from, for example, weather forecast information. When predicted output restriction plan information is calculated from weather information, the weather forecast information is inputted to the power output restriction planning unit 132 in the computer system 130 from the information network 300 via the router 170. In this example, an output restriction time period is predicted from past climate information and restriction information. The information obtained over the information network 300 may be obtained over the Internet or a dedicated line of the electric power company and may be obtained over a combination of these. For example, output restriction plan information and predicted output restriction plan information may be obtained over a dedicated line of the electric power company, and weather information may be obtained over the Internet. Output restriction plan information, predicted output restriction plan information, and weather information may be obtained by the power output restriction planning unit 132 fetching such information from a server that provides the information (electric power company or weather information providing server) or the server pushing such information to the power output restriction planning unit 132. The control unit 131 obtains output restriction plan information or predicted output restriction plan information from the power output restriction planning unit 132 when such information is needed (details will be given later). Meanwhile, the power output restriction planning unit 132 may obtain or calculate such (related) information via the router 170 upon request from the control unit 131 and may obtain or calculate the information in advance of such a request. When the power output restriction planning unit 132 obtains or calculates the information in advance of such a request, the power output restriction planning unit 132 may store obtained or calculated information and give the stored information to the control unit 131 upon request.

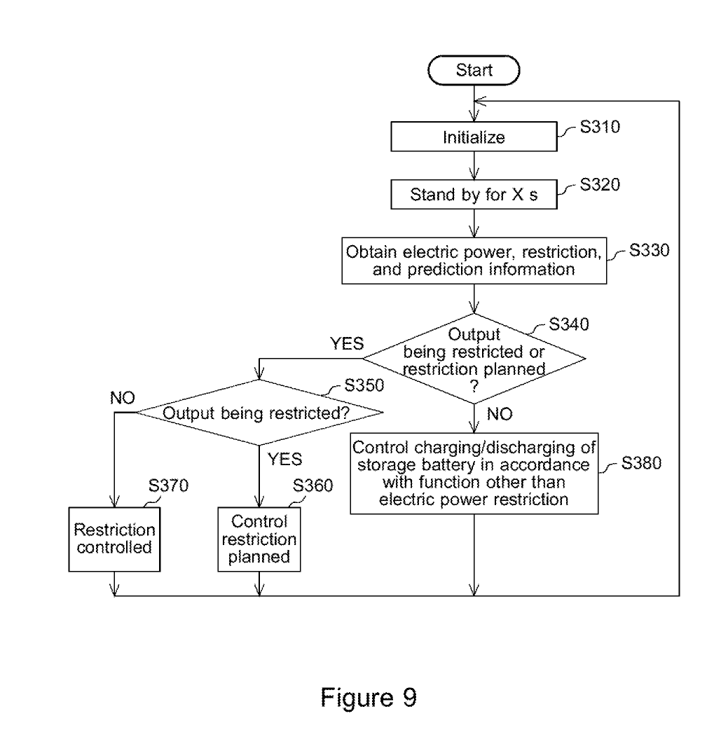

A control signal is used to control charging/discharging of the storage battery 121 in the storage battery system 120. The charging/discharging control includes, for example, the control of a switch of the storage battery 121 and the storage battery inverter 122 and the charging electric power and discharged electric power specified for the storage battery inverter 122. The control unit 131 performs details of such control. An example of such control implemented by the control unit 131 will be now described in reference to the simplified flow chart in FIG. 9. A control signal is transmitted to the computer system 130 using a special interface in the same manner as electric power information is transmitted.

Examples of the special interface include, but are not limited to, standard protocols such as ModBuS, CANBuS, RS-485, and SunSpec. An interface adapter capable of connecting to a personal computer (not shown in FIG. 8) may in some cases be used for these interfaces. An example of such an adapter is one that, for example, converts ModBuS digital electric signals to an Ethernet®, which is frequently used with computers.

In the flow chart of FIG. 9, after the system is started, the system is initialized in S310. This system initialization may include, for example, initialization of variables implemented in software for the flow chart, initialization of the solar power generation system 110 and the storage battery system 120, and checking of the status of the solar power generation system 110 and the storage battery system 120.

After the initialization in S310, the system stands by for a predetermined time of X seconds (e.g., 5 seconds) in step S320. The process then proceeds to step S330.

In step S330, electric power/state information is obtained from the solar power generation system 110, the storage battery system 120, and the breaker 150, and information on restriction, prediction, and the like is obtained from the power output restriction planning unit 132. The process then proceeds to step S340.

In step S340, the control unit 131 checks whether output to the system 200 is being restricted or such restriction is being planned. Restriction information may be, for example, a restriction time period and restricted electric power provided by the electric power company, prediction information provided as service over the information network 300, or information on restriction time predicted from weather forecasts. If the period of the day or the predicted restriction, provided by the electric power company, occurs in the future time, this restriction is planned to occur in the future time. Output is restricted during the period of the day provided by the electric power company. In these cases, the process proceeds to step S350. Otherwise, the process proceeds to step S380. For example, if restriction is being planned to occur within two days or after that, it may be determined that no prediction is made in the days before the preceding day of the prediction.

In the state of S350, it is ascertained whether or not power output is being restricted. Specifically, if the current time falls in the restriction time period provided by the electric power company, the process proceeds to step S360. Otherwise, the process proceeds to step S370. The storage battery 121 may be charged during the restriction time. If the storage battery 121 is charged during the restriction time, a DC bus to which the storage battery 121 and the storage battery inverter 122 are connected may in some cases need to be pre-charged before charging the storage battery 121. To this end, the process may proceed to S360 at least an amount of time before the start of the restriction time, the amount being equivalent of the length of the pre-charging period.

In step S360, first, charging electric power may be calculated from a difference between the electric power generated by the solar inverter 112 and the output-restricted electric power specified by the electric power company. For example, if 100 kW of electric power is generated and output is restricted to 30 kW, charging electric power equals to 100 kW−30 kW=70 kW. If output is completely prohibited, this calculation is unnecessary, and the total electric power generated from sunlight is stored.

When output-restricted electric power is smaller than generated electric power as in the example above, the storage battery 121 is instructed to charge on the differential electric power. The storage battery 121 and the storage battery inverter 122 have a maximum charging electric power. If the differential electric power is greater than this maximum, the storage battery 121 is instructed to charge as much as the maximum charging electric power. The maximum is a smaller one of a maximum for the storage battery 121 and a maximum for the storage battery inverter 122. As an example of the maximum charging electric power, the rated electric powers of the storage battery 121 and the storage battery inverter 122 may be restricted, or if the storage battery 121 is substantially fully charged, the charging electric power may be further restricted due to properties of the storage battery 121.

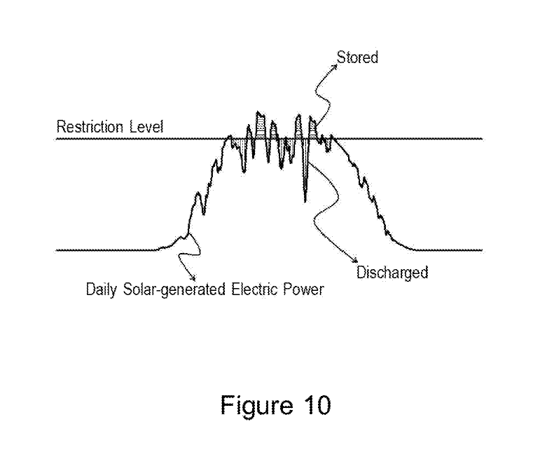

If there is a 0 difference or if the output-restricted electric power is greater than the generated electric power, the storage battery 121 may be instructed to suspend the charging/discharging operation thereof. If the storage battery 121 suspends the operation before the start of S360, there is no need to transmit such a suspension instruction again after the start of S360. Meanwhile, if the output-restricted electric power is greater than the generated electric power, the storage battery may discharge as much as the differential electric power. For example, where there are many cloudy days, a storage battery with a relatively small capacity can cope with output restriction by discharging during the restriction time. FIG. 10 shows an example of solar power generation on a cloudy day. For example, if generated electric power is greater than or equal to restricted electric power, the differential electric power is stored. If generated electric power is less than or equal to restricted electric power, electricity is discharged. A relatively small number of storage batteries 121 are sufficient if they are repeatedly charged and discharged during the restriction time period.

The storage battery 121 or the storage battery inverter 122 may normally in some cases be equipped with an internal (charge) switch for actually connecting the storage battery 121 to the storage battery inverter 122. If these switches are off before charging, the switches are turned on before the charging and electricity charged. Note that an ON instruction is outputted to the storage battery 121 or the storage battery inverter 122, the internal state of the storage battery 121 or the storage battery inverter 122 is obtained, and it is ascertained that the switches have been indeed turned on.

If there is a need to pre-charge before charging, a pre-charge process in which pre-charging for the purpose of charging (e.g., switch operation for pre-charging and checking DC bus voltage) is performed in advance.

After these operations, the process returns to step S320.

In step S370, there is a future plan for restriction (a restriction time is provided by the electric power company or predicted from, for example, climate information). The storage battery 121 is charged with the electric power generated from sunlight during a restriction time. The remaining empty capacity of the storage battery 121 is however preferably reduced to a minimum before the start of a restriction time, so that a sufficient part of the electric power rejected by the system 200 over the entire restriction time period can be used for charging. Therefore, once a restriction plan is ascertained, the storage battery 121 is preferably controlled to discharge before the restriction is started.

Thus, in step S370, for example, a discharge instruction is transmitted to the storage battery unless the remaining empty capacity of the storage battery 121 is a minimum. If it is a minimum, a charging/discharging suspension instruction is transmitted to the storage battery 121. Note that if the storage battery 121 has already suspended the charging/discharging operation thereof, there is no need to transmit such a suspension instruction again.

There is surplus electric power on the system 200 late at night. For this reason, if electric power is to be discharged to the system 200, the discharging may be controlled, for example, in such a manner as to discharge no electricity or only a small amount of electricity to the system 200 late at night and discharge a relatively large amount of electricity at other times so that the remaining empty capacity of the storage battery 121 is reduced to a minimum before the start of restriction. This control prevents wasting of electric power on a social scale.

The storage battery 121 or the storage battery inverter 122 may in some cases be equipped with a (discharge) switch for connecting the storage battery 121 to the storage battery inverter 122. These switches accordingly need to be controlled as they are in the charging control. Likewise, if pre-charging before discharging also needs to be performed, the pre-charging is also controlled.

After these operations, the process returns to step S320.

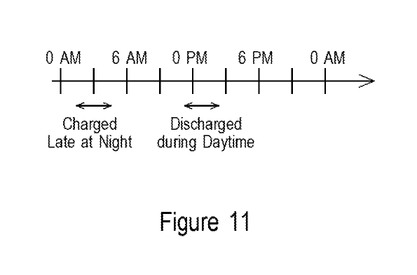

In S380, output is not being restricted, and there is no restriction planned for the future time. Therefore, the storage battery 121 may be used tor purposes other than output restriction. An example is peak shifting depicted in FIG. 11 where the storage battery 121 is charged late at night when there is surplus electric power on the system 200 and discharged during the daytime when there is relatively insufficient electric power. In such a case, in step S380, for example, the current time and the remaining empty capacity of the storage battery 121 are checked, and an instruction is transmitted to the storage battery 121 to charge, discharge, or suspend charging/discharging. The process then returns to step S320. Note that if an instruction is made to charge or discharge, a switch and pre-charging are also controlled as in S360 and S370 where necessary.

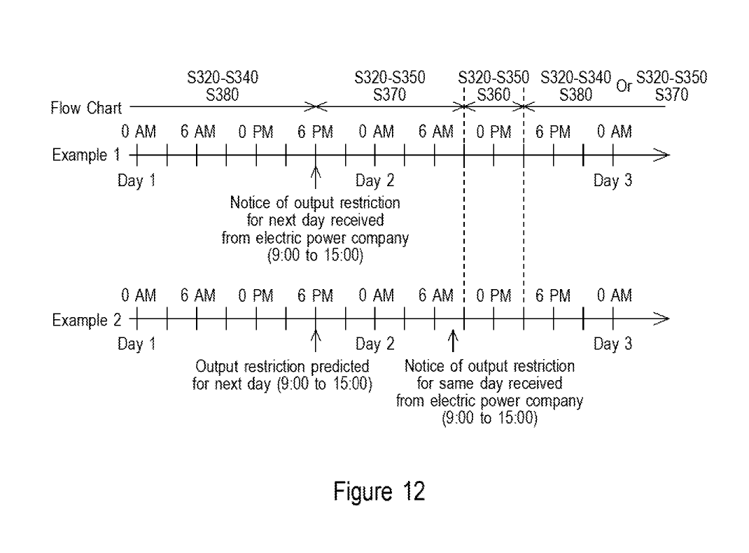

FIG. 12 shows an example of steps depicted in the flow chart of FIG. 9 as they are performed over a two-day period. The steps in the flow chart will be explained, and two examples will be given in the following description.

Assume that initially, output is not being restricted and there is no restriction planned for the future time. Due to this assumption, S320, S330, S340, and S380 in the flow chart are repeated.

Next, in Example 1 in FIG. 12, an output restriction notice for the next day is delivered by the electric power company at 18:00 on day 1. The restriction time period is from 9:00 to 15:00 in this example. Specifically, the control unit 131 carries out steps S320, S330, S340, S350, and S370 from 18:00 on day 1 to 9:00 on day 2.

Next, during the restriction time on day 2 (from 9:00 to 15:00), the control unit 131 carries out steps S320, S330, S340, S350, and S360.

Finally, starting at 15:00 on day 2, the control unit 131 carries out steps S320, S330, S340, and S380 if there is no output restriction planned for the next day. If there is one, the control unit 131 carries out steps S320, S330, S340, S350, and S370.

In Example 2 in FIG. 12, the power output restriction planning unit 132 predicts an output restriction for the next day at 18:00 on day 1. In such a case, the control unit 131 carries out steps S320, S330, S340, S350, and S370 starting at 18:00 on day 1. Then, at 8:00 on day 2, a restriction information for the same day is delivered by the electric power company. The control unit 131 continues to carry out steps S320, S330, S340, S350, and S370 until 9:00 when control is started. Starting at the time when restriction is started, the control unit 131 carries out steps S320, S330, S340, S350, and S360. Accordingly, even if a notice is delivered by the electric power company immediately before a restriction, the storage battery 121 is sufficiently discharged in step S370 on the previous day. If the storage battery 121 starts discharging after a notice is delivered at 8:00, the remaining empty capacity of the storage battery 121 may not be a minimum at the time when restriction is started.

This advance prediction of a restriction time enables the storage battery 121 to be discharged sufficiently to a minimum even if, for example, a restriction notice is delivered by the electric power company at the last moment. Alternatively, by discharging over a suitable period before the restriction time arrives, social and economic benefits are improved.

The storage battery 121 may be fully charged before the restriction time ends, for example, if the storage battery 121 has too small a capacity, if the storage battery 121 is not sufficiently discharged in advance, or if the restriction time is too long. In these cases, the control unit 131 transmits, to the solar power generation system 110, an output restriction control signal for the solar inverter 112 (this signal is not shown in FIG. 8) to restrict solar-generated electric power. A maximum output of the solar inverter 112 becomes the output-restricted electric power in this case.

The interface through which the electric power company obtains output restriction plan information is not necessarily provided over the information network 300. In such a case, for example, the information may be obtained through news or email, and a service may be used that provides a replacement interface on the information network 300.

### Fifth Embodiment

Next, a fifth embodiment will be described. The description below will focus on configurational differences from the fourth embodiment. Those elements which are substantially similar to the corresponding elements in the fourth embodiment will be given the same reference numerals, and their description may be omitted.

In the fifth embodiment, the solar panel 111 and the storage battery 121 share a single inverter.

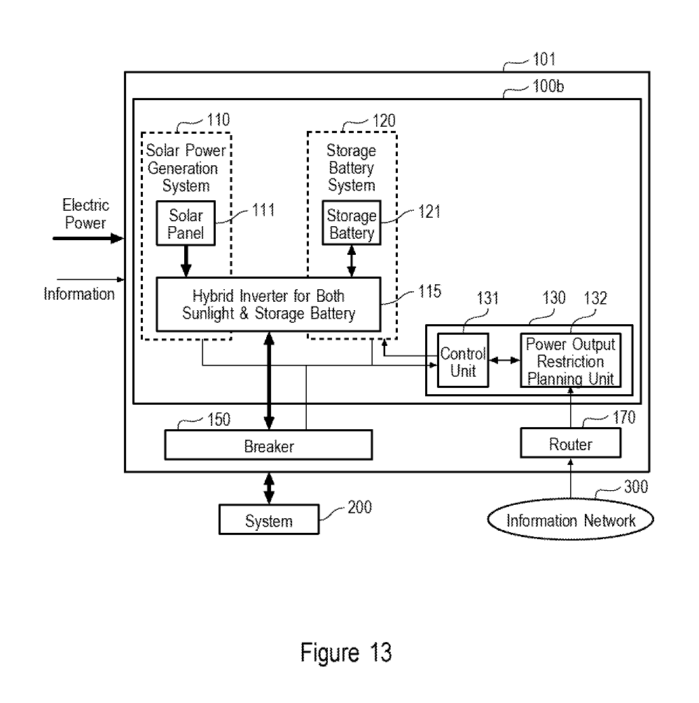

FIG. 8 shows the solar power generation system 110 and the storage battery system 120 as two separate systems. The solar inverter 112 and the storage battery inverter 122 may be replaced with a single hybrid inverter 115 as in FIG. 13. In this case, the solar panel 111 and the storage battery 121 may be connected directly on the DC side of the hybrid inverter 115.

When the hybrid inverter 115 is used, the electric power of the storage battery 121 in normal operation is given as follows:

Electric Power of Storage Battery=Indicated Electric Power for Inverter 115−Solar-generated Electric Power

Conditions: The three items above should be all either on the DC side or on the AC side. If both DC and AC exist in the equation above, the calculation should take the efficiency of the inverter 115 into account. The storage battery 121 discharges if indicated Electric Power for Inverter 115>0 and charges if Indicated Electric Power for Inverter 115<0.

The storage battery 121 discharges if Storage Battery Electric Power>0 and charges if Storage Battery Electric Power<0. Thus, the storage battery 121 discharges if Indicated Electric Power for Inverter 115>Solar-generated Electric Power and charges if Indicated Electric Power for inverter 115<Solar-generated Electric Power. In other words, if the indicated electric power for the inverter 115 is constant, the storage battery 121 may automatically switch from charging to discharging or vice versa depending on variations of the solar-generated electric power.

If, for example, no electric power is generated from sunlight, it follows that:

Storage Battery Electric Power=Indicated Electric Power for Inverter 115

When electric power is being generated from sunlight, and if the automatic switching between charging and discharging is undesirable, the indicated electric power for the inverter 115 is recalculated using the following equation by keeping track of solar-generated electric power, or the charge switch or the discharge switch of the storage battery 121 is turned off:

Indicated Electric Power for Inverter 115=Storage Battery Target Electric Power−Solar-generated Electric Power

Where the storage battery target electric power is the target electric power used to charge or discharge the storage battery 121.

A flow chart for the present embodiment would differ from the flow chart in FIG. 9 for the fourth embodiment in details of S360, S370, and S380.

In step S360, the discharge switch of the hybrid inverter 115 may be left turned off if, for example, the storage battery 121 is preferably not discharged due to requirements from the electric power company.

In step S370, because the storage battery 121 is preferably not charged, the charge switch of the hybrid inverter 115 is preferably left turned off, which is however not mandatory. This particular arrangement allows the storage battery 121 to charge, for example, on a day that precedes a restriction and causes the storage battery 121 to discharge late at night on the same day until the remaining empty capacity of the storage battery 121 is reduced to a minimum. Preferably, the storage battery 121 is not charged by solar-generated electric power prior to a restriction on the same day.

In step S380, the storage battery 121 may be charged/discharged for purposes other than output restriction. Use of the hybrid inverter 115 allows automatic switching from charging to discharging. Therefore, the control executed in S380 may be simplified in accordance with an intended use.

### Sixth Embodiment

Next, a sixth embodiment will be described. The description below will focus on configurational differences from the fourth and fifth embodiments. Those elements which are substantially similar to the corresponding elements in the fourth and fifth embodiments will be given the same reference numerals, and their description may be omitted.

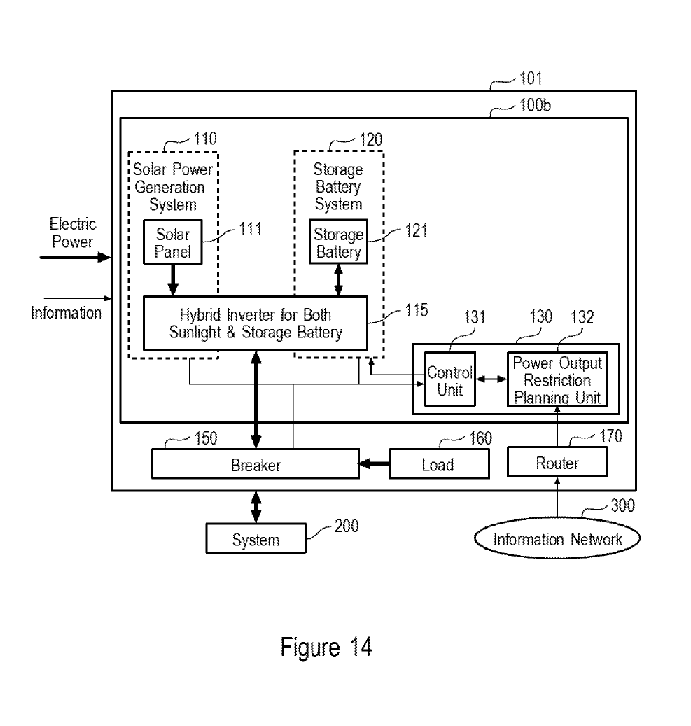

In the sixth embodiment, a load 160 is additionally installed at the installation site 101 as shown in FIG. 14. FIG. 14 is a variation of FIG. 13 of the fifth embodiment, which also applies to the case in FIG. 8 where no hybrid inverter is used (fourth embodiment).

The fourth and fifth embodiments described a solar power plant as an example. With the addition of the load 160, the present embodiment is directed to, for example, a home, an office, a factory, or a building. If, for example, the load 160 is connected to a breaker other than the breaker 150, however, the present system may be directed to the same type of facilitates as are the fourth and fifth embodiments.

The load 160 is, for example: a home electrical appliance in a home, such as an air conditioner, a television set, a refrigerator, or a luminaire; a device in an office, such as an air conditioner, a luminaire, a personal computer, or a printer; or an air conditioner, a luminaire, or a manufacturing machine in a factory.

The AC electric power produced by conversion in the inverters 112, 122, and 115 is outputted to the load 160, the system 200, or the storage battery system 120 via the breaker 150.

When the load 160 is added, processes differ depending on the definition of output restriction.

If output restriction is defined as solar-generated electric power, the control unit 131 operates in the present embodiment in the same manner as in the fourth or fifth embodiment.

If output restriction is defined as output to the system 200, the power consumption of the load 160 needs to be taken into account.

Specifically, in step S360 of FIG. 9, the electric power on which output restriction is performed is equal to the solar-generated electric power minus the power consumption of the load 160. In step S370, when compared with the fourth or fifth embodiment, the discharging of the storage battery 121 is controlled for improved economic advantages on the basis of the length of time up to the start of restriction, hourly electricity price, and the predicted power consumption of the load 160 by giving priority to a period of the day when electricity price is high, so that the remaining empty capacity is reduced to a minimum by the time when restriction is started. The predicted power consumption of the load 160 may be calculated, for example, by the power output restriction planning unit 132. Therefore, the power output restriction planning unit 132 predicts the power consumption of the load 160 on the basis of a past record of the power consumption of the load 160. To predict power consumption at a time on a weekday, as an example, the past record may be the average power consumption at the same time on past N weekdays.

To sum it up, the discharged electric power is calculated for each time period of the day, and a discharge instruction is made based on the calculation.

The discharged electric power is preferably less than or equal to the power consumption of the load 160 so that no electric power is exported from the storage battery 121 to the system 200.

The breaker 150 may collect information on the load 160. This information may be calculated on the computer system 130 from other information as a difference between the electric powers of the inverter and the system 200.

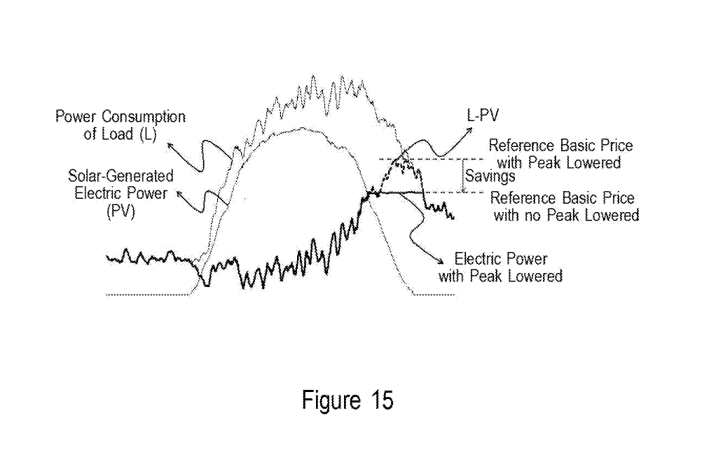

S380 may be implemented in such a manner as to achieve the function illustrated in FIG. 15 in which the storage battery is charged during a non-peak period and discharged during a peak period, for example, to lower an electric power peak (demand price) which serves as a reference for basic electricity price. FIG. 15 shows that the demand price is cheaper when the peak is clipped than it is determined from the peak (of the power consumption of the load minus the solar-generated electric power) without using a storage battery. In such a case, in step S380, the electric power being purchased from the system 200 is checked, and an instruction is transmitted to the storage battery in accordance with the strength of the peak of purchased electric power such that the storage battery charges, discharges, or suspends charging/discharging. The process then returns to step S320.

### Seventh Embodiment

Next, a seventh embodiment will be described. The description below will focus on configurational differences from the fourth to sixth embodiments. Those elements which are substantially similar to the corresponding elements in the fourth to sixth embodiments will be given the same reference numerals, and their description may be omitted.

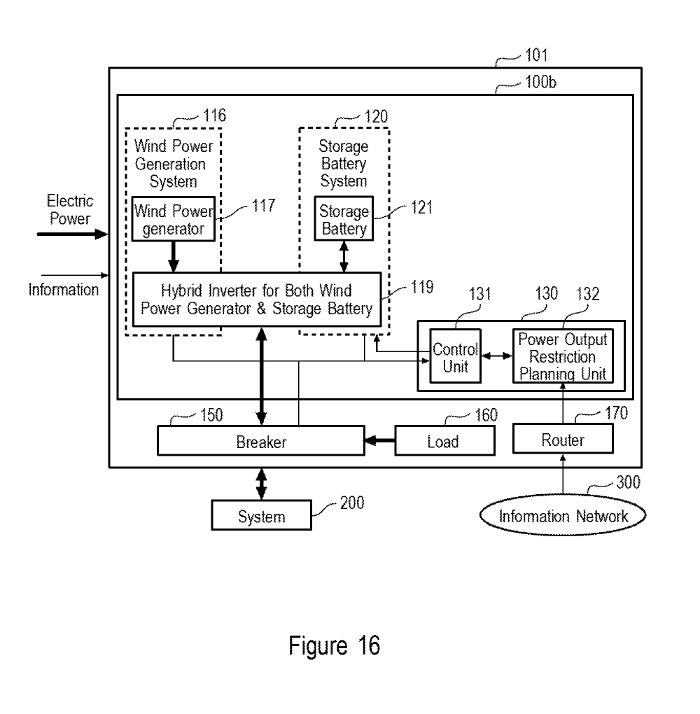

In the present embodiment, electric power is generated form wind power instead of sunlight. FIG. 16 is drawn on the basis of the configuration of the seventh embodiment (FIG. 8). The arrangement in which wind power generation is utilized may also be applicable to the configuration of the fourth embodiment (FIG. 13) and the configuration of the fifth embodiment (FIG. 14).

A wind power generation system 116 is used in FIG. 16 instead of the solar power generation system 110. The wind power generation system 116 includes a wind power generator 117 and a hybrid inverter 119 used commonly by both the wind power generation system 116 and the storage battery system 120. The wind power generation system 116, if configured as in FIG. 8, would include an inverter separately from the storage battery system 120.

The control unit 131 basically operates in the same manner as it does in the solar power generation system 110. Specifically, the control unit 131, upon being informed of a restriction time period in advance by an electric power company or upon predicting a restriction time in advance, controls the storage battery to discharge until the start of the restriction and to charge during the restriction time. The wind power generation system 116 differs from the solar power generation system 110 in that while the solar power generation system 110 generates electric power only during the daytime, the wind power generation system 116 can generate electric power at an arbitrary time. Thus, in the wind power generation system 116, the wind power generator 117 may generate power from the time when an output restriction time is known or predicted until the start of output restriction. The storage battery 121 is discharged during this time period.

### Overview of Fourth to Seventh Embodiments

An energy management system 100b in accordance with any one of the fourth to the seventh embodiments may control charging/discharging of a storage battery 121, the energy management system 100b including: an electric power generation unit 110; a storage battery unit 120; a power output restriction planning unit 132; and a control unit 131, the control unit 131 transmitting a discharge instruction to instruct the storage battery unit 120 to discharge either over an entire period that lasts from a planned input time to a restriction start time or during a part of that period if the power output restriction planning unit 132 already has an output restriction plan and transmitting a charge instruction to charge the storage battery unit 120 with electric power generated by the electric power generation unit 110 either over an entire restriction period or during a part of the restriction period (tenth arrangement). Thus, the electric power that cannot be outputted to the system 200 during the electric power restriction determined by an electric power company can be used in a broader range of applications by charging/discharging the storage battery 121 in a suitable manner.

The energy management system 100b in accordance with the tenth arrangement above may be arranged such that the output restriction plan in the power output restriction planning unit 132 includes a notice from an electric power company obtained over an information network 300 (eleventh arrangement).

The energy management system 100b in accordance with the tenth arrangement above may be arranged such that the output restriction plan in the power output restriction planning unit 132 is prepared from weather forecast information obtained over an information network 300 (twelfth arrangement).

The energy management system 100b in accordance with the tenth arrangement above may be arranged such that the discharge instruction is such that the storage battery unit discharges preferentially in a time period of a day when there is no surplus electric power in a system 200 (thirteenth arrangement).

The energy management system 100b in accordance with the tenth arrangement above may further include a load 160 in a premise here the energy management system 100b is installed, wherein the discharge instruction is such that the storage battery unit discharges in a time period of a day based on information on predicted power consumption of the load 160 (fourteenth arrangement).

The energy management system 100b in accordance with the tenth arrangement above may be arranged such that the control unit 131 transmits the discharge instruction to instruct the storage battery unit 121 to discharge if electric power generated by the electric power generation unit 110 during the restriction period is lower than electric power in the output restriction plan in the power output restriction planning unit 132 (fifteenth arrangement).

The energy management system 100b in accordance with the tenth arrangement above may be arranged such that the control unit 131 transmits an instruction to charge, discharge, or suspend charging/discharging of the storage battery unit 121 in a period that lasts from an end of the restriction period to a next output restriction plan (sixteenth arrangement).

An energy management device 130 in accordance with any one of the fourth to the seventh embodiments may control charging of a storage battery 121 with electric power generated by an energy power generation device 111 and discharging of the storage battery 121, the energy management device 130 including a power output restriction planning unit 132 and a control unit 131, wherein the control unit 131 transmits a discharge instruction to instruct the storage battery 121 to discharge either over an entire period that lasts from a planned input time to a restriction start time or during a part of that period when the control unit 131 receives an output restriction plan from the power output restriction planning unit 131 and transmits a charge instruction to charge the storage battery 121 with the electric power generated by the energy power generation device 111 either over an entire restriction period or during a part of the restriction period (seventeenth arrangement).

A control method in accordance with any one of the fourth to the seventh embodiments may be executed by an energy management device 130 controlling charging of a storage battery 121 with electric power generated by an energy power generation device 111 and discharging of the storage battery 121, the method including: obtaining an output restriction plan according to which an output of the energy power generation device 111 is restricted; transmitting a discharge instruction to instruct the storage battery 121 to discharge either over an entire period that lasts from a time when the output restriction plan is obtained to a start of a restriction period contained in the output restriction plan or during a part of that period; and transmitting a charge instruction to charge the storage battery 121 with the electric power generated by the energy power generation device 111 either over the entire restriction period or during a part of the restriction period (eighteenth arrangement).

Embodiments of the present invention have been described so far. The embodiments described above are illustrative only and may be modified in combinations of elements and processes, and all such modifications are obvious and included within the scope of the present invention as would be understood by one skilled in the art.

### REFERENCE SIGNS LIST

100a Power Generation System

1 String of Solar Cells

2 Power Storage Device

3 Power Conditioner (PCS)

31 DC/DC Converter

32 Inverter

33 Bidirectional DC/DC Converter

34 Smoothing Capacitor

35 Communication Unit

36 Memory Unit

37 CPU

38 Bidirectional inverter

371 Power Monitoring Unit

372 Power Storage Monitoring Unit

373 Conversion Control Unit

374 Timer

375 Information Obtaining Unit

376 Target Setting Unit

4 Controller

41 Display Unit

42 Input Unit

43 Communication Unit

44 Communication I/F

45 CPU

BL Bus Line

P Power Distribution Path

M Electric Energy Meter

CS Commercial Electric Power System

LS Electric Power Load System

NT Network

100b Energy Management System

110 Solar Power Generation System

111 Solar Panel

112 Solar Inverter

115 Hybrid Inverter

120 Storage Battery System

121 Storage Battery

122 Storage Battery Inverter

130 Computer System

131 Control Unit

132 Power Output Restriction Planning Unit

150 Breaker

160 Load

170 Router

101 Location Where System is Installed

200 System

300 Information Network

116 Wind Power Generation System

117 Wind Power Generator

119 Hybrid Inverter for Both Wind Power Generator and Storage

1. A control device controlling an energy storage device capable of storing electric power generated in a power generation facility that is operated in conjunction with an electric power system,
the control device controlling the energy storage device based on output restriction information on an output-restricting period during which electric power outputted from the power generation facility to the electric power system is restricted, such that the energy storage device stores the generated electric power during the output-restricting period.

2. The control device according to claim 1,
wherein the control device controls the energy storage device based on a prediction of how much electric power is generated by a power generation device in the power generation facility in each time period of a day and also based on the output restriction information, the prediction being made based on information on a factor for day-to-day and period-to-period variations of the generated electric power.

3. The control device according to claim 1, wherein the control device controls a charge level of the energy storage device that the energy storage device exhibits at a start of the output-restricting period.

4. The control device according to claim 1 wherein the control device: sets a target value for energy stored in the energy storage device for each time period of a day based on the output restriction information and on a prediction of how much electric power is generated by a power generation device in each of the time periods; controls the stored energy based on the target values for the time periods; and sets a first target value for a first time period of the day that encompasses the output-restricting period and a second target value for a second time period of the day that immediately precedes the first time period of the day, the second target value being lower than the first target value.

5. The control device according to claim 1 wherein the control device controls the energy storage device based further on either power demand information or electricity price information or both, the power demand information containing predicted period-to-period power consumption of an electric power load connected to the power generation facility and the electricity price information containing a period-to-period price of electric power supplied from the electric power system to either one or both of the power generation facility and the electric power load.

6. The control device according to claim 1, wherein information on a factor for day-to-day and period-to-period variations of the generated electric power includes calendrical information and weather information containing period-to-period weather forecasts in a geographical region in and around a location where the power generation device is installed.

7. A control device controlling an energy storage device capable of storing electric power generated in a power generation facility that is operated in conjunction with an electric power system,
the control device, if output restriction information on an output-restricting period during which electric power outputted from the power generation facility to the electric power system is restricted indicates that there is such an output-restricting period, controlling a charge level of the energy storage device during the output-restricting period based on the output restriction information, such that the charge level is lower than would be if the output restriction information indicated that there was no output-restricting period at that time.

8. A system comprising: the control device according to claim 1; and an energy storage device.

9. (canceled)

10. An energy management system controlling charging/discharging of a storage battery, the energy management system comprising: an electric power generation unit; a storage battery unit; a power output restriction planning unit; and a control unit, the control unit transmitting a discharge instruction to instruct the storage battery unit to discharge either over an entire period that lasts from a planned input time to a restriction start time or during a part of that period if the power output restriction planning unit already has an output restriction plan and transmitting a charge instruction to charge the storage battery unit with electric power generated by the electric power generation unit either over an entire restriction period or during a part of the restriction period.

11. The energy management system according to claim 10, wherein the output restriction plan in the power output restriction planning unit includes a notice from an electric power company obtained over an information network.

12. The energy management system according to claim 10, wherein the output restriction plan in the power output restriction planning unit is prepared from weather forecast information obtained over an information network.

13. The energy management system according to claim 10, wherein the discharge instruction is such that the storage battery unit discharges preferentially in a time period of a day when there is no surplus electric power in an electric power system.

14. The energy management system according to claim 10, further comprising a. load in a premise where the energy management system is installed, wherein the discharge instruction is such that the storage battery unit discharges in a time period of a day based on information on predicted power consumption of the load.

15. The energy management system according to claim 10, wherein the control unit transmits the discharge instruction to instruct the storage battery unit to discharge if electric power generated by the electric power generation unit during the restriction period is lower than electric power in the output restriction plan in the power output restriction planning unit.

16. The energy management system according to claim 10, wherein the control unit transmits an instruction to charge, discharge, or suspend charging/discharging of the storage battery unit in a period that lasts from an end of the restriction period to a next output restriction plan.

17-18. (canceled)
